(19) United States
(12) Patent Application Publication
(10) Pub. No.: US 2026/0260484 A1
(43) Pub. Date: Sep. 3, 2026

(54) System, Method, and Computer Program Product for Identifying Transparencies

(71) Applicant: Vitro Flat Glass LLC, Cheswick, PA (US)

(72) Inventors: Martin Bracamonte, Jupiter, FL (US); Fernando Diez Flores, Cheswick, PA (US)

(21) Appl. No.: 19/550,722

(22) Filed: Feb. 26, 2026

Related U.S. Application Data
(60) Provisional application No. 63/764,682, filed on Feb. 28, 2025.

(51) Int. Cl. G06V 20/10; G06T 7/90; G06V 10/60

(52) U.S. Cl. CPC G06V 20/176; G06T 7/90; G06V 10/60; G06T 2207/10024

(57) ABSTRACT

Systems, methods, and computer program products are provided for identifying transparencies. An example system includes at least one processor that is configured to receive at least one input from a mobile device positioned in proximity to a building including at least one transparency visible from an exterior of the building. The at least one processor is also configured to determine at least one transparency identifier based on the at least one input received from the mobile device. The at least one processor is further configured to cause the mobile device to provide the at least one transparency identifier to a user of the mobile device.

### CROSS-REFERENCE TO RELATED APPLICATION

This application claims priority to U.S. Provisional Patent Application No. 63/764,682, filed Feb. 28, 2025, titled “System, Method, and Computer Program Product for Identifying Transparencies”, the disclosure of which is incorporated by reference in its entirety.

### BACKGROUND

### 1. Technical Field

This disclosure relates generally to transparencies and, in non-limiting embodiments or aspects, to systems, methods, and computer program products for identifying transparencies.

### 2. Technical Considerations

Transparencies (e.g., window glass, automotive glass, etc.) may be used in many applications (e.g., buildings, automobiles, etc.). Transparencies may exhibit many different visual properties (e.g., hue, reflectivity, transmittance, refraction, texture, etc.) that may affect the style and selection for use in a given application (e.g., in the façade of a building). The identity of a transparency (e.g., make, model, manufacturer, etc.) may not be apparent to a user or individual who is not involved in the installation of the transparency. It may be difficult or impossible to determine an identity of a transparency, or a similar type of transparency, based on individual user perception. This may be further complicated by different varieties of glass exhibiting very similar observable features that are difficult to discern with human perception. Moreover, a viewer may have the desire to determine an identity of a transparency, or a similar type of transparency, to acquire the same or similar transparency for use in another application (e.g., determining an identifier of a transparency used in a building façade, for the purpose of acquiring the same or similar for use in another building façade). There is a need in the art to automatically identify one or more transparencies.

### SUMMARY

Accordingly, provided are improved systems, methods, and computer program products for identifying transparencies.

According to non-limiting embodiments or aspects, provided is a system for identifying transparencies. The system includes at least one processor. The at least one processor is configured to receive at least one input from a mobile device positioned in proximity to a building including at least one transparency visible from an exterior of the building. The at least one processor is also configured to determine at least one transparency identifier based on the at least one input received from the mobile device. The at least one processor is further configured to cause the mobile device to provide the at least one transparency identifier to a user of the mobile device.

In some non-limiting embodiments or aspects, the at least one input from the mobile device may include visual data generated by the mobile device based on at least one image captured by an imaging device of the mobile device. The visual data may be associated with at least a portion of the at least one image corresponding to a part of the building.

In some non-limiting embodiments or aspects, the visual data may include at least one of the following: color data, saturation data, hue data, brightness data, contrast data, or any combination thereof.

In some non-limiting embodiments or aspects, when determining the at least one transparency identifier based on the at least one input, the at least one processor may be configured to perform a series of steps. The series of steps may include determining at least one detected color value based on the at least one input. The series of steps may also include comparing the at least one detected color value to a set of color values, each color value of the set of color values being associated with a transparency identifier of a set of transparency identifiers. The series of steps may further include determining the at least one transparency identifier based on at least one color value of the set of color values being closest or equivalent to the at least one detected color value.

In some non-limiting embodiments or aspects, the set of color values may include a set of transmitted color values. Each transmitted color value may be associated with a transmittance of a transparency that is associated with a transparency identifier of the set of transparency identifiers.

In some non-limiting embodiments or aspects, the set of color values may include a set of reflected color values. Each reflected color value may be associated with a reflectance of a transparency that is associated with a transparency identifier of the set of transparency identifiers.

In some non-limiting embodiments or aspects, the set of color values may include a plurality of color value extrema. Each color value extrema of the plurality of color value extrema may include a maximum color value and a minimum color value. Each color value extrema of the plurality of color value extrema may be associated with a transparency identifier of the set of transparency identifiers.

In some non-limiting embodiments or aspects, when determining the at least one transparency identifier based on the at least one color value of the set of color values being closest to the at least one detected color value, the at least one processor may be configured to determine an average color value of at least one color value extrema of the plurality of color value extrema that is closest to the at least one detected color value.

In some non-limiting embodiments or aspects, the at least one processor may be further configured to store, in a memory, a set of geolocations of buildings. Each geolocation of the set of geolocations may be associated with one or more transparency identifiers. The at least one input may include location data of the mobile device. When determining the at least one transparency identifier based on the at least one input, the at least one processor may be configured to perform a series of steps. The series of steps may include determining at least one detected geolocation from the location data. The series of steps may also include comparing the at least one detected geolocation to the set of geolocations. The series of steps may further include determining the at least one transparency identifier based on at least one geolocation of the set of geolocations being closest or equivalent to the at least one detected geolocation.

In some non-limiting embodiments or aspects, the at least one processor may be further configured to store, in a memory, a set of geolocations of buildings. Each geolocation of the set of geolocations may be associated with a subset of transparency identifiers. The at least one input may further include location data of the mobile device. When determining the at least one transparency identifier based on the at least one input, the at least one processor may be configured to perform a series of steps. The series of steps may include determining at least one detected geolocation from the location data. The series of steps may also include comparing the at least one detected geolocation to the set of geolocations. The series of steps may further include determining a candidate geolocation of the set of geolocations being closest or equivalent to the at least one detected geolocation. The series of steps may further include determining a candidate subset of transparency identifiers based on the candidate geolocation. The series of steps may further include determining at least one detected color value based on the at least one input. The series of steps may further include comparing the at least one detected color value to a set of color values, each color value of the set of color values being associated with a transparency identifier of the candidate subset of transparency identifiers. The series of steps may further include determining the at least one transparency identifier based on at least one color value of the set of color values being closest or equivalent to the at least one detected color value.

According to some non-limiting embodiments or aspects, provided is a method for identifying transparencies. The method may include receiving, with at least one processor, at least one input from a mobile device positioned in proximity to a building including at least one transparency visible from an exterior of the building. The method may also include determining, with at least one processor, at least one transparency identifier based on the at least one input received from the mobile device. The method may further include causing, with at least one processor, the mobile device to provide the at least one transparency identifier to a user of the mobile device.

In some non-limiting embodiments or aspects, the at least one input from the mobile device may include visual data generated by the mobile device based on at least one image captured by an imaging device of the mobile device. The visual data may be associated with at least a portion of the at least one image corresponding to a part of the building.

In some non-limiting embodiments or aspects, determining the at least one transparency identifier based on the at least one input may include a series of steps. The series of steps may include determining at least one detected color value based on the at least one input. The series of steps may also include comparing the at least one detected color value to a set of color values, each color value of the set of color values being associated with a transparency identifier of a set of transparency identifiers. The series of steps may further include determining the at least one transparency identifier based on at least one color value of the set of color values being closest or equivalent to the at least one detected color value.

In some non-limiting embodiments or aspects, the method may further include storing, in a memory, a set of geolocations of buildings. Each geolocation of the set of geolocations may be associated with one or more transparency identifiers. The at least one input may include location data of the mobile device. Determining the at least one transparency identifier based on the at least one input may include a series of steps. The series of steps may include determining at least one detected geolocation from the location data. The series of steps may also include comparing the at least one detected geolocation to the set of geolocations. The series of steps may further include determining the at least one transparency identifier based on at least one geolocation of the set of geolocations being closest or equivalent to the at least one detected geolocation.

In some non-limiting embodiments or aspects, the method may further include storing, in a memory, a set of geolocations of buildings. Each geolocation of the set of geolocations may be associated with a subset of transparency identifiers. The at least one input may further include location data of the mobile device. Determining the at least one transparency identifier based on the at least one input may include performing a series of steps. The series of steps may include determining at least one detected geolocation from the location data. The series of steps may also include comparing the at least one detected geolocation to the set of geolocations. The series of steps may further include determining a candidate geolocation of the set of geolocations being closest or equivalent to the at least one detected geolocation. The series of steps may further include determining a candidate subset of transparency identifiers based on the candidate geolocation. The series of steps may further include determining at least one detected color value based on the at least one input. The series of steps may further include comparing the at least one detected color value to a set of color values, each color value of the set of color values being associated with a transparency identifier of the candidate subset of transparency identifiers. The series of steps may further include determining the at least one transparency identifier based on at least one color value of the set of color values being closest or equivalent to the at least one detected color value.

According to some non-limiting embodiments or aspects, provided is a computer program product for identifying transparencies. The computer program product includes at least one non-transitory computer-readable medium including program instructions that, when executed by at least one processor, cause the at least one processor to receive at least one input from a mobile device positioned in proximity to a building including at least one transparency visible from an exterior of the building. The program instructions also cause the at least one processor to determine at least one transparency identifier based on the at least one input received from the mobile device. The program instructions further cause the at least one processor to cause the mobile device to provide the at least one transparency identifier to a user of the mobile device.

In some non-limiting embodiments or aspects, the at least one input from the mobile device may include visual data generated by the mobile device based on at least one image captured by an imaging device of the mobile device. The visual data may be associated with at least a portion of the at least one image corresponding to a part of the building.

In some non-limiting embodiments or aspects, the program instructions that cause the at least one processor to determine the at least one transparency identifier based on the at least one input may cause the at least one processor to perform a series of steps. The series of steps may include determining at least one detected color value based on the at least one input. The series of steps may also include comparing the at least one detected color value to a set of color values, each color value of the set of color values being associated with a transparency identifier of a set of transparency identifiers. The series of steps may further include determining the at least one transparency identifier based on at least one color value of the set of color values being closest or equivalent to the at least one detected color value.

In some non-limiting embodiments or aspects, the program instructions may further cause the at least one processor to store, in a memory, a set of geolocations of buildings. Each geolocation of the set of geolocations may be associated with one or more transparency identifiers. The at least one input may include location data of the mobile device. The program instructions that cause the at least one processor to determine the at least one transparency identifier based on the at least one input may cause the at least one processor to perform a series of steps. The series of steps may include determining at least one detected geolocation from the location data. The series of steps may also include comparing the at least one detected geolocation to the set of geolocations. The series of steps may further include determining the at least one transparency identifier based on at least one geolocation of the set of geolocations being closest or equivalent to the at least one detected geolocation.

In some non-limiting embodiments or aspects, the program instructions may further cause the at least one processor to store, in a memory, a set of geolocations of buildings. Each geolocation of the set of geolocations may be associated with a subset of transparency identifiers. The at least one input may further include location data of the mobile device. The program instructions that cause the at least one processor to determine the at least one transparency identifier based on the at least one input may cause the at least one processor to perform a series of steps. The series of steps may include determining at least one detected geolocation from the location data. The series of steps may also include comparing the at least one detected geolocation to the set of geolocations. The series of steps may further include determining a candidate geolocation of the set of geolocations being closest or equivalent to the at least one detected geolocation. The series of steps may further include determining a candidate subset of transparency identifiers based on the candidate geolocation. The series of steps may further include determining at least one detected color value based on the at least one input. The series of steps may further include comparing the at least one detected color value to a set of color values, each color value of the set of color values being associated with a transparency identifier of the candidate subset of transparency identifiers. The series of steps may further include determining the at least one transparency identifier based on at least one color value of the set of color values being closest or equivalent to the at least one detected color value.

According to some non-limiting embodiments or aspects, provided is a system for identifying transparencies. The system includes at least one processor. The at least one processor is configured to provide a plurality of visual properties of a plurality of transparencies generated using at least one imaging device. The at least one processor is also configured to receive, from a computing device, an input. The at least one processor is further configured to determine a color value from the input. The at least one processor is further configured to compare the color value to the plurality of visual properties of the plurality of transparencies. The at least one processor is further configured to determine at least one transparency identifier based on the comparing of the color value to the plurality of visual properties of the plurality of transparencies. The at least one processor is further configured to transmit the at least one transparency identifier to the computing device.

Further non-limiting embodiments or aspects are set forth in the following numbered clauses:
Clause 1: A system, comprising: at least one processor configured to: receive at least one input from a mobile device positioned in proximity to a building comprising at least one transparency visible from an exterior of the building; determine at least one transparency identifier based on the at least one input received from the mobile device; and cause the mobile device to provide the at least one transparency identifier to a user of the mobile device.
Clause 2: The system of clause 1, wherein the at least one input from the mobile device comprises visual data generated by the mobile device based on at least one image captured by an imaging device of the mobile device, and wherein the visual data is associated with at least a portion of the at least one image corresponding to a part of the building.
Clause 3: The system of clause 1 or clause 2, wherein the visual data comprises at least one of the following: color data, saturation data, hue data, brightness data, contrast data, or any combination thereof.
Clause 4: The system of any of clauses 1-3, wherein, when determining the at least one transparency identifier based on the at least one input, the at least one processor is configured to: determine at least one detected color value based on the at least one input; compare the at least one detected color value to a set of color values, each color value of the set of color values being associated with a transparency identifier of a set of transparency identifiers; and determine the at least one transparency identifier based on at least one color value of the set of color values being closest or equivalent to the at least one detected color value.

Clause 5: The system of any of clauses 1-4, wherein the set of color values comprises a set of transmitted color values, and wherein each transmitted color value is associated with a transmittance of a transparency that is associated with a transparency identifier of the set of transparency identifiers.

Clause 6: The system of any of clauses 1-5, wherein the set of color values comprises a set of reflected color values, and wherein each reflected color value is associated with a reflectance of a transparency that is associated with a transparency identifier of the set of transparency identifiers.

Clause 7: The system of any of clauses 1-6, wherein the set of color values comprises a plurality of color value extrema, each color value extrema of the plurality of color value extrema comprising a maximum color value and a minimum color value, and each color value extrema of the plurality of color value extrema being associated with a transparency identifier of the set of transparency identifiers.

Clause 8: The system of any of clauses 1-7, wherein, when determining the at least one transparency identifier based on the at least one color value of the set of color values being closest to the at least one detected color value, the at least one processor is configured to determine an average color value of at least one color value extrema of the plurality of color value extrema that is closest to the at least one detected color value.

Clause 9: The system of any of clauses 1-8, wherein the at least one processor is further configured to store, in a memory, a set of geolocations of buildings, each geolocation of the set of geolocations being associated with one or more transparency identifiers, wherein the at least one input comprises location data of the mobile device, and wherein, when determining the at least one transparency identifier based on the at least one input, the at least one processor is configured to: determine at least one detected geolocation from the location data; compare the at least one detected geolocation to the set of geolocations; and determine the at least one transparency identifier based on at least one geolocation of the set of geolocations being closest or equivalent to the at least one detected geolocation.

Clause 10: The system of any of clauses 1-9, wherein the at least one processor is further configured to store, in a memory, a set of geolocations of buildings, each geolocation of the set of geolocations being associated with a subset of transparency identifiers, wherein the at least one input further comprises location data of the mobile device, and wherein, when determining the at least one transparency identifier based on the at least one input, the at least one processor is configured to: determine at least one detected geolocation from the location data; compare the at least one detected geolocation to the set of geolocations; determine a candidate geolocation of the set of geolocations being closest or equivalent to the at least one detected geolocation; determine a candidate subset of transparency identifiers based on the candidate geolocation; determine at least one detected color value based on the at least one input; compare the at least one detected color value to a set of color values, each color value of the set of color values being associated with a transparency identifier of the candidate subset of transparency identifiers; and determine the at least one transparency identifier based on at least one color value of the set of color values being closest or equivalent to the at least one detected color value.

Clause 11: A computer-implemented method, comprising: receiving, with at least one processor, at least one input from a mobile device positioned in proximity to a building comprising at least one transparency visible from an exterior of the building; determining, with at least one processor, at least one transparency identifier based on the at least one input received from the mobile device; and causing, with at least one processor, the mobile device to provide the at least one transparency identifier to a user of the mobile device.

Clause 12: The computer-implemented method of clause 11, wherein the at least one input from the mobile device comprises visual data generated by the mobile device based on at least one image captured by an imaging device of the mobile device, and wherein the visual data is associated with at least a portion of the at least one image corresponding to a part of the building.

Clause 13: The computer-implemented method of clause 11 or clause 12, wherein determining the at least one transparency identifier based on the at least one input comprises: determining at least one detected color value based on the at least one input; comparing the at least one detected color value to a set of color values, each color value of the set of color values being associated with a transparency identifier of a set of transparency identifiers; and determining the at least one transparency identifier based on at least one color value of the set of color values being closest or equivalent to the at least one detected color value.

Clause 14: The computer-implemented method of any of clauses 11-13, further comprising storing, in a memory, a set of geolocations of buildings, each geolocation of the set of geolocations being associated with one or more transparency identifiers, wherein the at least one input comprises location data of the mobile device, and wherein determining the at least one transparency identifier based on the at least one input comprises: determining at least one detected geolocation from the location data; comparing the at least one detected geolocation to the set of geolocations; and determining the at least one transparency identifier based on at least one geolocation of the set of geolocations being closest or equivalent to the at least one detected geolocation.

Clause 15: The computer-implemented method of any of clauses 11-14, further comprising storing, in a memory, a set of geolocations of buildings, each geolocation of the set of geolocations being associated with a subset of transparency identifiers, wherein the at least one input further comprises location data of the mobile device, and wherein determining the at least one transparency identifier based on the at least one input comprises: determining at least one detected geolocation from the location data; comparing the at least one detected geolocation to the set of geolocations; determining a candidate geolocation of the set of geolocations being closest or equivalent to the at least one detected geolocation; determining a candidate subset of transparency identifiers based on the candidate geolocation; determining at least one detected color value based on the at least one input; comparing the at least one detected color value to a set of color values, each color value of the set of color values being associated with a transparency identifier of the candidate subset of transparency identifiers; and determining the at least one transparency identifier based on at least one color value of the set of color values being closest or equivalent to the at least one detected color value.

Clause 16: A computer program product comprising at least one non-transitory computer-readable medium including program instructions that, when executed by at least one processor, cause the at least one processor to: receive at least one input from a mobile device positioned in proximity to a building comprising at least one transparency visible from an exterior of the building; determine at least one transparency identifier based on the at least one input received from the mobile device; and cause the mobile device to provide the at least one transparency identifier to a user of the mobile device.

Clause 17: The computer program product of clause 16, wherein the at least one input from the mobile device comprises visual data generated by the mobile device based on at least one image captured by an imaging device of the mobile device, and wherein the visual data is associated with at least a portion of the at least one image corresponding to a part of the building.

Clause 18: The computer program product of clause 16 or clause 17, wherein the program instructions that cause the at least one processor to determine the at least one transparency identifier based on the at least one input cause the at least one processor to: determine at least one detected color value based on the at least one input; compare the at least one detected color value to a set of color values, each color value of the set of color values being associated with a transparency identifier of a set of transparency identifiers; and determine the at least one transparency identifier based on at least one color value of the set of color values being closest or equivalent to the at least one detected color value.

Clause 19: The computer program product of any of clauses 16-18, wherein the program instructions further cause the at least one processor to store, in a memory, a set of geolocations of buildings, each geolocation of the set of geolocations being associated with one or more transparency identifiers, wherein the at least one input comprises location data of the mobile device, and wherein the program instructions that cause the at least one processor to determine the at least one transparency identifier based on the at least one input cause the at least one processor to: determine at least one detected geolocation from the location data; compare the at least one detected geolocation to the set of geolocations; and determine the at least one transparency identifier based on at least one geolocation of the set of geolocations being closest or equivalent to the at least one detected geolocation.

Clause 20: The computer program product of any of clauses 16-19, wherein the program instructions further cause the at least one processor to store, in a memory, a set of geolocations of buildings, each geolocation of the set of geolocations being associated with a subset of transparency identifiers, wherein the at least one input further comprises location data of the mobile device, and wherein the program instructions that cause the at least one processor to determine the at least one transparency identifier based on the at least one input cause the at least one processor to: determine at least one detected geolocation from the location data; compare the at least one detected geolocation to the set of geolocations; determine a candidate geolocation of the set of geolocations being closest or equivalent to the at least one detected geolocation; determine a candidate subset of transparency identifiers based on the candidate geolocation; determine at least one detected color value based on the at least one input; compare the at least one detected color value to a set of color values, each color value of the set of color values being associated with a transparency identifier of the candidate subset of transparency identifiers; and determine the at least one transparency identifier based on at least one color value of the set of color values being closest or equivalent to the at least one detected color value.

Clause 21: A system comprising: at least one processor configured to: provide a plurality of visual properties of a plurality of transparencies generated using at least one imaging device; receive, from a computing device, an input; determine a color value from the input; compare the color value to the plurality of visual properties of the plurality of transparencies; determine at least one transparency identifier based on the comparing of the color value to the plurality of visual properties of the plurality of transparencies; and transmit the at least one transparency identifier to the computing device.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for identifying transparencies, according to some non-limiting embodiments or aspects;

FIG. 2 is a schematic diagram of example components of one or more devices of FIG. 1, according to some non-limiting embodiments or aspects;

FIG. 3 is a flow diagram of a method for identifying transparencies, according to some non-limiting embodiments or aspects;

FIG. 4 is a view of a user interface for use in a system and method for identifying transparencies, according to some non-limiting embodiments or aspects;

FIG. 5 is a view of a user interface for use in a system and method for identifying transparencies, according to some non-limiting embodiments or aspects;

FIG. 6 is a view of a user interface for use in a system and method for identifying transparencies, according to some non-limiting embodiments or aspects;

FIG. 7 is a view of a user interface for use in a system and method for identifying transparencies, according to some non-limiting embodiments or aspects;

FIG. 8 is a view of a user interface for use in a system and method for identifying transparencies, according to some non-limiting embodiments or aspects;

FIG. 9 is a view of a user interface for use in a system and method for identifying transparencies, according to some non-limiting embodiments or aspects;

FIG. 10 is a view of a user interface for use in a system and method for identifying transparencies, according to some non-limiting embodiments or aspects;

FIG. 11 is a view of a user interface for use in a system and method for identifying transparencies, according to some non-limiting embodiments or aspects;

FIG. 12 is a view of a user interface for use in a system and method for identifying transparencies, according to some non-limiting embodiments or aspects;

FIG. 13 is a view of a user interface for use in a system and method for identifying transparencies, according to some non-limiting embodiments or aspects;

FIG. 14 is a view of a user interface for use in a system and method for identifying transparencies, according to some non-limiting embodiments or aspects;

FIG. 15 is a view of a user interface for use in a system and method for identifying transparencies, according to some non-limiting embodiments or aspects;

FIG. 16 is a view of a user interface for use in a system and method for identifying transparencies, according to some non-limiting embodiments or aspects;

FIG. 17 is a view of a user interface for use in a system and method for identifying transparencies, according to some non-limiting embodiments or aspects;

FIG. 18 is a view of a user interface for use in a system and method for identifying transparencies, according to some non-limiting embodiments or aspects;

FIG. 19 is a view of a user interface for use in a system and method for identifying transparencies, according to some non-limiting embodiments or aspects; and

FIG. 20 is a view of a user interface for use in a system and method for identifying transparencies, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, desktop computers, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Described systems, devices, and methods provide a new and improved technical ecosystem for identifying transparencies. By storing a centralized database of transparencies throughout a region and identifying transparencies based on one or more inputs of data from a computing device, the described systems can provide real-time feedback to users of an identity of a transparency, or its equivalent, that actually exists in the region. Accuracy and speed may be improved based on an input of location data, from which the described systems may identify a building and/or set of transparencies based on a proximity to the input of location. Moreover, such a configuration may directly apply the feedback to a computing device reporting its own location, such that identified buildings and/or transparencies are related to a proximity of the computing device in a physical environment. One or more computing devices also need not locally store information individually on the respective computing devices. By centralizing the information of predetermined buildings and/or transparencies in a centralized database, overall system memory requirements are reduced, and more local memory and processing capacity on said computing devices may be dedicated to image capture, image processing, geolocation services, user interface display, and/or the like, freeing computing resources locally for other aspects of the user-machine interface experience.

Further to the above, the described systems, devices, and methods provide identification capabilities beyond the faculties of human perception or organization. To that end, a processor may receive input data from computing devices including visual data, which may be analyzed to determine one or more color values therein, to a degree of precision not capable by humans. Moreover, human color perception is notoriously subjective and fallible, and variances in color between transparencies can be imperceptibly subtle, such that the described systems, devices, and methods could not be effectively replaced by humans working individually or in concert. By way of further illustration, a processor may determine color data, saturation data, hue data, brightness data, contrast data, or a combination thereof from received visual data, and determine at least one transparency identifier based on the image data, via correspondence to transparencies predetermined exhibited qualities of color and light. Differences in the observable environment, in which an imaged transparency is located, can also be accounted for using the described systems, devices, and methods, by taking into account ranges of color values and color value extrema exhibited by various transparencies in a testing environment. In the manner described above and herein, the described systems, devices, and methods provide a new and unique technical ecosystem for rapidly and accurately identifying one or more transparencies based on analyzed computer input, including location data, visual data, and/or the like.

Accurately identifying transparencies has many direct downstream applications for various industries. For example, in architecture, it may be important to select a transparency (e.g., glass) with a specific color property for aesthetic purposes, to control light transmission, to control heat transmission, and/or the like. In the automotive industry, transparencies such as windshields and rear/side windows may be carefully selected for optimal light transmission and color balance for safety and comfort. Therefore, it will be appreciated that the techniques described herein may be readily applied to identify transparencies and optimize the selection and deployment in a given application.

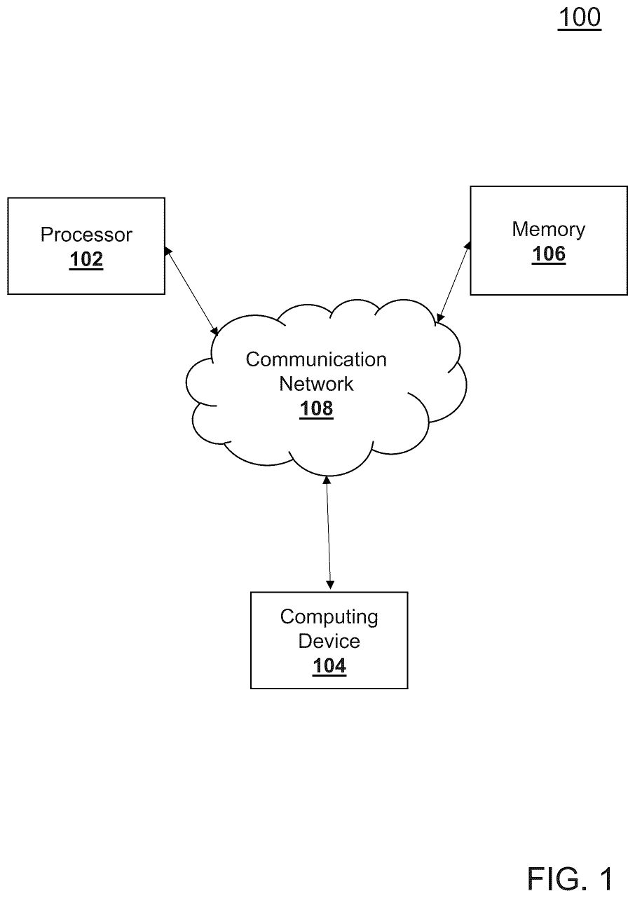

Referring now to FIG. 1, shown is a system 100 for identifying transparencies, according to some non-limiting embodiments or aspects. System 100 may include processor 102, computing device 104, memory 106, and/or communication network 108.

Processor 102 may include one or more computing devices for identifying transparencies. Processor 102 may be communicatively connected to computing device 104 via one or more communication networks, such as communication network 108. Processor 102 may include, or be included in, a same computing device or system as computing device 104 and/or memory 106. Processor 102 may be configured to receive one or more inputs (e.g., geolocation, visual data, and/or the like) from computing device 104 in order to determine one or more transparency identifiers (e.g., model number, alphanumeric code, part identification text and/or number, token, and/or the like), based on the one or more inputs. Processor 102 may be further configured to cause computing device 104 to provide the one or more transparency identifiers to a user of computing device 104, such as by causing computing device 104 to display (e.g., on a display screen), audibilize (e.g., via one or more speakers), graphically represent (e.g., on a display screen), and/or the like, the one or more determined transparency identifiers.

Computing device 104 may include one or more computing devices. Computing device 104 may be communicatively connected to processor 102 via one or more communication networks, such as communication network 108. Computing device 104 may include, or be included in, a same computing device or system as processor 102 and/or memory 106. In some non-limiting embodiments or aspects, computing device 104 may be a mobile device. In configurations where computing device 104 is a mobile device, the described systems may have further advantages of identifying transparencies that are proximal to the mobile device, such that the identification is practical as to the location of the mobile device in a physical environment (e.g., near a building that has one or more visible transparencies). In some non-limiting embodiments or aspects, computing device 104 may be a desktop or laptop computer, which need not be proximal to a transparency in order to provide input to processor 102 for analysis. Such scenarios may provide other advantages, such as identifying a plurality of transparencies in batch processing, identifying transparencies that are far from the location of computing device 104, identifying transparencies based on other data besides location, and/or the like. Such scenarios would also allow for identifying transparencies based on theoretical visual properties, as compared to observed visual properties.

In some non-limiting embodiments or aspects, computing device 104 may provide user access to a native application, website, or other user interface with communicative connection to processor 102 and/or memory 106. The application, website, or other interface may allow the user to provide input, such as visual data from a camera of computing device 104, location data from a global positioning system (GPS) receiver of computing device 104, or data in one or more entry forms. The application, website, or other interface may connect to processor 102 and/or memory 106 over one or more communication networks 108 to receive one or more transparency identifiers in response to the transmission of input, including one or more transparency descriptions, images, and/or the like, based on the input submitted in the application, website, or other interface. In some non-limiting embodiments or aspects, the application, website, or other interface may launch a camera application on computing device 104 to allow the user to capture an image, at least a portion of which may be used as visual data.

Memory 106 may include, or be included in, one or more computing devices. Memory 106 may include at least one non-transitory, computer-readable medium configured to store data of buildings and/or transparencies, including geolocations, transparency identifiers, one or more color visual properties (e.g., color values) associated with transparency identifiers, one or more building identifiers associated with transparency identifiers, one or more geolocations associated with transparency identifiers, transparency descriptions, transparency costs, and/or the like. Memory 106 may store data in one or more databases (e.g., a cloud-networked server cluster configured for communication with processor 102 and/or computing device 104). Memory 106 may include, or be included in, a same computing device or system as processor 102 and/or computing device 104. In some non-limiting embodiments or aspects, memory 106 may include a local storage medium and/or cache on computing device 104, whereby computing device 104 may retain part or all of a database of transparency information. In such scenarios, retrieval time of transparency-related data may be increased, and network connectivity to an externally stored memory 106 may be eliminated. In some non-limiting embodiments or aspects, memory 106 may be non-local to computing device 104 and accessed by processor 102 (e.g., a processor on or separate from computing device 104), such that memory storage requirements on individual computing devices 104 is reduced. Memory savings from centralizing memory 106 may be amplified when considering a network of computing devices 104 and the aggregated memory savings across the network.

Communication network 108 may include one or more wired and/or wireless networks over which the systems and devices of system 100 may communicate. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of system 100 may perform one or more functions described as being performed by another set of systems or another set of devices of system 100.

In some non-limiting embodiments or aspects, processor 102 and/or computing device 104 may be configured to perform one or more steps of a method for identifying transparencies. For example, processor 102 may receive at least one input (e.g., location data, visual data, and/or the like) from computing device 104 (e.g., a mobile device, such as a smartphone). Location data may include, but is not limited to: decimal degrees (DD); degrees, minutes, and seconds (DMS); altitude; accuracy; timestamp; location source (e.g., global position system (GPS), wireless internet connection, cellular data connection, etc.); geofencing data; place name and/or address; and/or the like. Location data may be stored in various formats, including, but not limited to, plain text (e.g., in comma-separated value (CSV) structure); JavaScript Object Notation (JSON); extensible markup language (XML); and/or the like. Visual data may include, but is not limited to, color data, saturation data, hue data, brightness data, contrast data, pixel data, resolution, color depth, and/or the like. Visual data may be stored and/or transmitted in various formats, including, but not limited to, plain text, alphanumeric, encoded value, hexadecimal (HEX) value, red-green-blue (RGB) value, cyan-magenta-yellow-black (CMYK) value, hue-saturation-lightness (HSL) value, LAB color value (lightness value, A-axis value, B-axis value), Joint Photographic Experts Group format (.jpg or .jpeg), Portable Network Graphics format (.png), High Efficiency Image File format (.heif or .heic), uncompressed and/or unprocessed image format (e.g., raw files), Moving Picture Experts Group format (e.g., .mp4), QuickTime® Movie format (.mov), Third Generation Partnership format (.3gp), and/or the like.

In some non-limiting embodiments or aspects, the at least one input may include visual data generated by computing device 104 based on at least one image captured by an imaging device (e.g., a camera) of computing device 104. For example, an imaging device of computing device 104 may capture at least one image of a building having at least one transparency, and the transparency may be visible in the one or more captured images. The visual data based on the at least one image may be based on at least a portion of the at least one image corresponding to a part of the building (e.g., the transparency, a façade, a coating, and/or the like).

In some non-limiting embodiments or aspects, computing device 104 may be positioned in proximity to a building (e.g., a man-made construction) including at least one transparency (e.g., window, glass surface, glass feature, etc.), which may be visible from an exterior and/or an interior of the building. Computing device 104 may be in proximity to a building when the building is within visual range of a camera of computing device 104, within an immediate connectivity range of a data network on which computing device 104 is communicating (e.g., 100-200 feet for a wireless internet connection, 2000-5000 feet for a cellular data connection, and/or the like), within a short walking distance of a user holding computing device 104 (e.g., 400-1200 feet), and/or the like.

In some non-limiting embodiments or aspects, processor 102 may determine at least one transparency identifier based on the at least one input received from computing device 104. In some non-limiting embodiments or aspects, when determining the at least one transparency identifier based on the at least one input, processor 102 may be configured to perform a series of steps related to visual analysis. The series of steps related to visual analysis may include determining at least one detected color value (e.g., HEX value, RGB value, CMYK value, LAB value, and/or the like) based on the at least one input. For example, processor 102 may determine a region of colored values (e.g., a pixel region) that includes all or part of a captured image (e.g., including one or more pixels). Processor 102 may select one or more color values from the region, average one or more color values from the region, and/or the like, to determine one or more detected color values. Next, in the series of steps related to visual analysis, processor 102 may compare the at least one detected color value to a set of color values (e.g., each set of color values including one or more color values). Each color value of the set of color values may be associated with a transparency identifier of a set of transparency identifiers (e.g., each set of transparency identifiers including one or more transparency identifiers). For example, the set of transparency identifiers may include a plurality of transparency identifiers stored in memory 106, and each transparency identifier thereof may be stored in association with one or more color values or portions of color values. Processor 102 may determine the at least one transparency identifier based on at least one color value of the set of color values being closest (e.g., smallest deviation, or delta) or equivalent to (e.g., matching) the at least one detected color value.

The color that is perceived when observing (e.g., imaging) a transparency may be a combination of transmitted and reflected light. “Transmitted light” refers to the portion of light that passes through a transparency. The transparency may absorb some wavelengths of light while allowing others to pass through. This selective absorption may contribute to the color of the transparency. For example, green glass absorbs most wavelengths except green, which is transmitted. “Reflected light” refers to the portion of light that reflects off the surface of the transparency. This reflected light can also contribute to the perceived color of the transparency, especially if the transparency is tinted or coated. In some embodiments or aspects, reflected light metrics may include transmitted light, as light coming through a transparency may be combined with reflected light to create a combined impression of the total light emitted from the transparency. It will be appreciated that references to transmitted and reflected color values may be combined for similar metrics for total light imaged.

Color value may be technically described using a few different methods: spectral value; color coordinates; color rendering index (CRI); and/or the like. Spectral value may refer to the measurement of the percentage of light transmitted through or reflected from the transparency at each wavelength across the visible spectrum. This data may be plotted on a graph to show the transmission and/or reflectance characteristics of the transparency. Color coordinates may refer to the quantification of color using color coordinates such as, but not limited to, the International Commission on Illumination (CIE) XYZ coordinate system, the CIE LAB coordinate system, and/or the like. Color rendering index (CRI) may refer to the measurement of how accurately the transparency transmits and/or reflects color compared to a perfect light source. A CRI of 100 may mean that the transparency transmits and/or reflects colors perfectly, while lower values indicate that some colors may appear distorted. Physical properties of transparencies may affect the transmitted and/or reflected color value. Transparency composition (e.g., chemical makeup), for example, of the transparency may affect color, as different additives may produce a wide range of colors. Transparency thickness may affect color, as thicker material generally absorbs more light, which may lead to a more intense color. Coatings applied to the transparency may alter the transparency's transmission and reflection properties, affecting perceived color. Furthermore, lighting conditions (e.g., a color of a light source) may also affect how a transparency appears.

In some non-limiting embodiments or aspects, a set of color values associated with a transparency identifier may include a set of transmitted color values, wherein each transmitted color value is associated with a transmittance of a transparency that is associated with a transparency identifier of the set of transparency identifiers. For example, memory 106 may store a table of transparencies, wherein each row corresponds to a transparency identifier, and each column corresponds to a property of the transparency. Columns may include, but are not limited to, an L*color value (of a LAB color system), an a*color value (of a LAB color system), a b*color value (of a LAB color system), an R color value (of an RGB color system), a G color value (of an RGB color system), a B color value (of an RGB color system), and/or the like, for both transmitted light and reflected light, and for average value, maximum value, minimum value, and/or the like of the same. Columns may further include, but are not limited to, a transparency description, a transparency identifier, a transmittance value (e.g., a color value), a reflectance value (e.g., a color value), and/or the like.

In some non-limiting embodiments or aspects, processor 102 may convert a detected color value, based on the received input from computing device 104, to a format in common with stored color values associated with transparencies. Additionally, or alternatively, processor 102 may convert a stored color value associated with transparencies to a format in common with a detected color value based on the input. For example, processor 102 may determine at least one detected color value based on the at least one input originally in a HEX value, convert the HEX value to an RGB value, then compare the detected color value (in RGB format) to stored color values associated with transparencies (also in RGB format) to determine which transparency has stored color values closest to or equivalent to the detected color value. The detected color value may be compared to a transmitted color value, a reflected color value, or a combination of both (e.g., an average, a closest or equivalent to one or the other, etc.).

In some non-limiting embodiments or aspects, the set of color values stored in association with each transparency identifier may include a plurality of color value extrema (e.g., maximum value, minimum value, etc.). For example, for color values stored in RGB format, memory 106 may store a transmitted light R maximum value, a transmitted light R minimum value, a transmitted light R average value, a transmitted light G maximum value, a transmitted light minimum G value, a transmitted light average G value, a transmitted light maximum B value, a transmitted light minimum B value, a transmitted light average B value, a reflected light R maximum value, a reflected light R minimum value, a reflected light R average value, a reflected light G maximum value, a reflected light minimum G value, a reflected light average G value, a reflected light maximum B value, a reflected light minimum B value, a reflected light average B value, a transmitted light L*maximum value, a transmitted light L*minimum value, a transmitted light L*average value, a transmitted light a*maximum value, a transmitted light minimum a*value, a transmitted light average a*value, a transmitted light maximum b*value, a transmitted light minimum b*value, a transmitted light average b*value, a reflected light L*maximum value, a reflected light L*minimum value, a reflected light L*average value, a reflected light a*maximum value, a reflected light minimum a*value, a reflected light average a*value, a reflected light maximum b*value, a reflected light minimum b*value, a reflected light average b*value, or any combination thereof. Maximum, minimum, and average values may be predetermined and stored for each transparency in memory 106 by imaging the transparencies in a controlled testing environment, such as with color-controlled surfaces and lighting (e.g., a white room). Processor 102 may compare a detected color value to one or more extrema color values for an identification of a closest or equivalent color value.

In some non-limiting embodiments or aspects, when determining the at least one transparency identifier based on the at least one color value of the set of color values being closest to the at least one detected color value, processor 102 may be configured to determine an average color value of at least one color value extrema of the plurality of color value extrema that is closest to the at least one detected color value. For example, processor 102 may, for each transparency, determine an average value of each color value component (e.g., R, G, B, L*, a*, b*, and/or the like) for a given color representation system. Processor 102 may do so by referencing an average value field and/or computing an average based on a maximum value field and a minimum value field. By way of further example, processor 102 may determine that a given transparency has a maximum transmitted R value of 230, a minimum transmitted R value of 220, a maximum transmitted G value of 210, a minimum transmitted G value of 200, a maximum transmitted B value of 250, and a minimum transmitted B value of 242. Processor 102 may average each set of extrema to determine an average transmitted RGB value of (235, 205, 246). Processor 102 may then compare the detected color value (e.g., after any necessary conversion to the same color value representation system) to each transparency's average transmitted RGB value to determine which transparency is closest in average transmitted RGB value (e.g., determined by a vector length between RGB values) and/or an equivalent (e.g., determined by a matching RGB value) to the detected color value. It will be appreciated that the above techniques may be similarly applied to calculating averages for extrema in other color representation systems (e.g., such as a LAB color system), and for reflected light.

In some non-limiting embodiments or aspects, processor 102 may identify a plurality of transparency identifiers having color values that are closest to the detected color value. Because various environmental conditions may affect a detected color determined from visual data provided by computing device 104, more than one transparency may have predetermined color values that are relatively proximal to the detected color value. For that reason, and to mitigate for noise and variability in the data collection, processor 102 may determine a plurality of transparency identifiers that are most likely candidates (e.g., ranked and/or selected by color values being closest to the detected color value), and provide transparency identifiers for the plurality of transparencies to computing device 104.

In some non-limiting embodiments or aspects, processor 102 may be configured to determine at least one transparency identifier based on input including location data. For example, memory 106 may store a set of geolocations of buildings. Each geolocation may be related to a location of a building in a region (e.g., on Earth, in several countries, in a country, in a state, in a metropolitan area, etc.) and may be stored as location data. Each building of a plurality of buildings may be associated with a geolocation that is stored in memory 106. For example, the John W. Olver Design Building, home of an academic department in Amherst, Massachusetts, is a building with prominent transparencies visible from an exterior of the building. Memory 106 may store a geolocation of such a building, such as in a DMS latitude and longitude of {° 23′17.412″ N, 72° 31′ 25.1364″ W}. This geolocation may be associated with one or more transparency identifiers, such as to correspond the identity of transparencies used in the construction of the building at that location, or equivalent transparencies thereto.

In some non-limiting embodiments or aspects, the input received from computing device 104 may include location data. For configurations where computing device 104 is a mobile device, the location data may correspond to a location of the mobile device. When determining that at least one transparency identifier based on the at least one input, processor 102 may be configured to determine at least one detected geolocation from the location data received from computing device 104 (e.g., including any conversion by processor 102 from a native format of the received geolocation to a format compatible for comparison with geolocations stored in memory 106); compare the at least one detected geolocation to the set of geolocations; and determine the at least one transparency identifier based on at least one geolocation of the set of geolocations being closest to or equivalent to the at least one detected geolocation.

In some non-limiting embodiments or aspects, processor 102 may use both location data and visual data from input from computing device 104 to determine at least one transparency identifier. For example, processor 102 may determine at least one detected geolocation from the location data. Processor 102 may compare the at least one detected geolocation to the set of geolocations stored in memory 106. Processor 102 may determine a candidate geolocation of the set of geolocations being closest or equivalent to the at least one detected geolocation. Processor 102 may then determine a candidate subset of transparency identifiers based on the candidate geolocation. Processor 102 may determine at least one detected color value based on the visual data of the input. Processor 102 may compare the at least one detected color value to a set of color values, each color value of the set of color values being associated with a transparency identifier of the candidate subset of transparency identifiers. Processor 102 may then determine the at least one transparency identifier based on at least one color value of the set of color values being closest or equivalent to the at least one detected color value.

Provided is a first non-limiting illustration for one such use of the above-described methods. A user may be walking on a sidewalk through Amherst, Massachusetts, and see a building (the John W. Olver Design Building) that has aesthetically pleasing windows that the user would like to procure for a different building project (e.g., an in-process or completed physical building structure). The user may pull out their smartphone (e.g., computing device 104) and launch a native application that provides a user interface and is connected to processor 102 via an application programming interface (API). The user may select a button in the native application named “Use my location”, which may trigger the collection of location data of a current location of their smartphone, using a GPS receiver on their smartphone. The location data may be transmitted from the smartphone to processor 102, which may receive the location data and determine at least one detected geolocation from the location data, the geolocation being represented by a unique identifier or other representation of the location data, such as in DMS format. For the purposes of illustration only, the user is holding their smartphone and is standing at {42° 23′ 15.0612″ N, 72° 31′ 24.654″ W}. Processor 102 may compare the detected geolocation to a set of geolocations, which may correspond to buildings that have transparencies. Processor 102 may determine that the John W. Olver Design Building has the closest stored geolocation to the detected geolocation. Processor 102 may then determine a subset of transparency identifiers (of all transparency identifiers) that are associated with the John W. Olver Design Building, such as identifiers associated with Solarban® 60 Glass and Solarban® 70 Glass. Processor 102 may then cause the smartphone to provide the transparency identifiers to the user, such as by causing the native application to update to include a description of the transparencies, a depiction of the transparencies, and/or the like.

Provided is a second non-limiting illustration for another such use of the above-described methods. A user may be walking on a sidewalk through Amherst, Massachusetts, and see a building (the John W. Olver Design Building) that has aesthetically pleasing windows that the user would like to procure for a different building project. The user may pull out their smartphone (e.g., computing device 104) and launch a native application that provides a user interface and is connected to processor 102 via an API. The user may select a button in the native application named “Take picture”, that uses the camera of the smartphone to launch a color-picker tool based on what the user is capturing in the camera. The user may capture an image that includes at least a portion of the building, such as the transparency. The native application may convert the selected portion of the image to visual data (e.g., a HEX color value) and transmit the visual data to processor 102. Processor 102 may then determine at least one detected color value based on the input from the smartphone (e.g., including any necessary conversions of the color value format, such as from HEX color value to RGB color value). Processor 102 may then compare the at least one detected color value to a set of color values, each color value being associated with a transparency identifier of a set of transparency identifiers. In doing so, processor 102 may determine that the observed HEX color value, when converted to RGB color value, is closest to the RGB color value stored for Solarban® 60 Glass. Processor 102 may then cause the smartphone to provide the transparency identifier to the user, such as by causing the native application to update to include a description of the transparency, a depiction of the transparency, and/or the like.

Provided is a third non-limiting illustration for another such use of the above-described methods. A user may be walking on a sidewalk through Amherst, Massachusetts, and see a building (the John W. Olver Design Building) that has aesthetically pleasing windows that the user would like to procure for a different building project. The user may pull out their smartphone (e.g., computing device 104) and launch a native application that provides a user interface and is connected to processor 102 via an API. The user may select a button in the native application named “Take picture”, that uses the camera of the smartphone to launch a color-picker tool based on what the user is capturing in the camera. The user may capture an image that includes at least a portion of the building, such as the transparency. The native application may convert the selected portion of the image to visual data (e.g., a HEX color value) and transmit the visual data to processor 102, along with location data of where the image was taken. Processor 102 may first use the location data to determine candidate geolocation that is closest to or equivalent to a detected geolocation, as determined from the location data. Processor 102 may then determine a candidate set of transparency identifiers based on the candidate geolocation, which may include identifiers for Solarban® 60 Glass and Solarban® 70 Glass. Processor 102 may then determine at least one detected color value based on the input from the smartphone (e.g., including any necessary conversions of the color value format, such as from HEX color value to RGB color value). Processor 102 may then compare the at least one detected color value to a set of color values, each color value being associated with a transparency identifier of the candidate set transparency identifiers. In doing so, processor 102 may determine that the observed HEX color value, when converted to RGB color value, is closest to the RGB color value stored for Solarban® 60 Glass. Processor 102 may then cause the smartphone to provide the transparency identifier to the user, such as by causing the native application to update to include a description of the transparency, a depiction of the transparency, and/or the like.

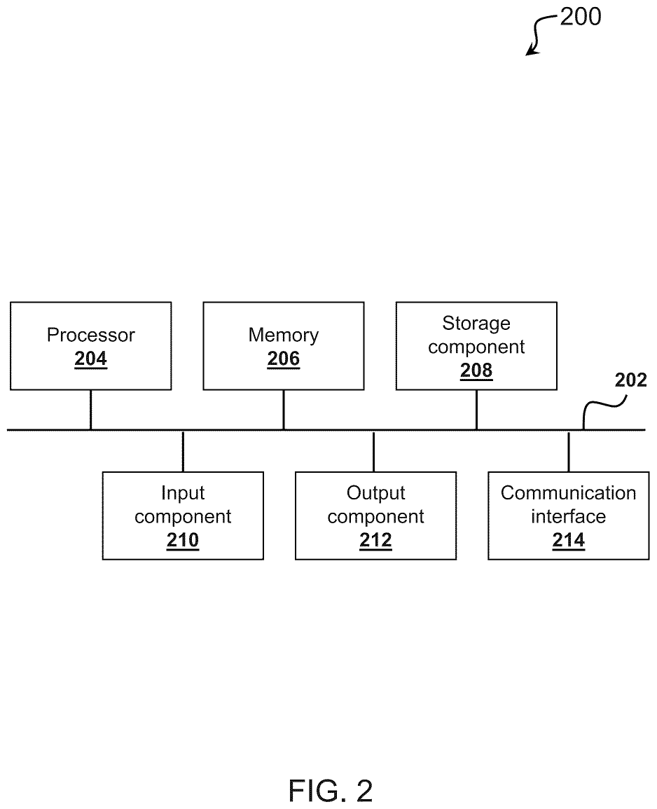

Referring now to FIG. 2, shown is a diagram of example components of a device 200, according to non-limiting embodiments. Device 200 may correspond to processor 102, computing device 104, memory 106, and/or communication network 108, as an example. In some non-limiting embodiments, such systems or devices may include at least one device 200 and/or at least one component of device 200. The number and arrangement of components shown are provided as an example. In some non-limiting embodiments, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include a bus 202, a processor 204, memory 206, a storage component 208, an input component 210, an output component 212, and a communication interface 214. Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

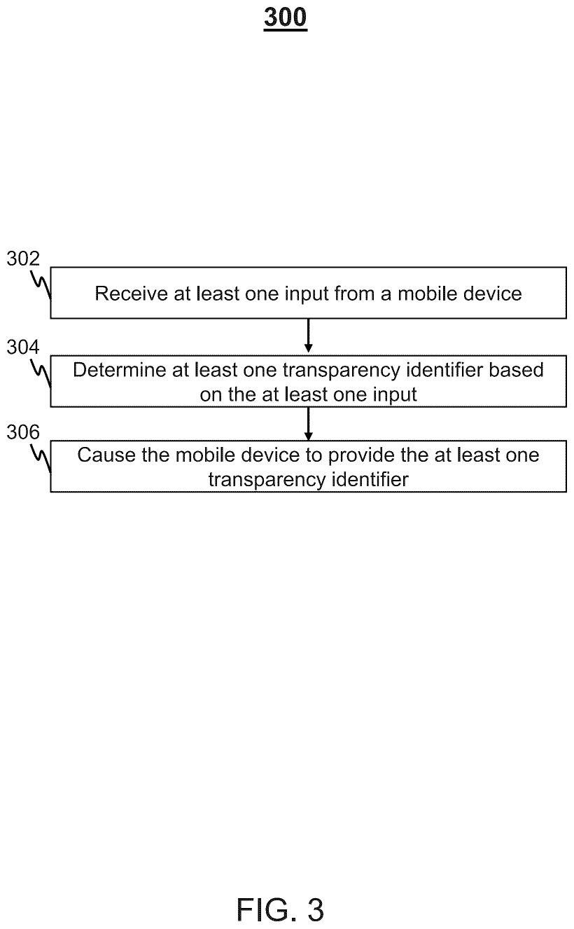

Referring now to FIG. 3, shown is a flow diagram of method 300 for identifying transparencies, according to some non-limiting embodiments or aspects. The steps shown in FIG. 3 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. One or more steps of method 300 may be performed by processor 102. Additionally, or alternatively, one or more steps of method 300 may be performed by another processor than processor 102.

As shown in FIG. 3, method 300 may include, at step 302, receiving at least one input from a mobile device. For example, processor 102 may receive at least one input from a mobile device (e.g., computing device 104) positioned in proximity to a building including at least one transparency visible from an exterior of the building.

In some non-limiting embodiments or aspects, the at least one input from the mobile device may include visual data generated by the mobile device based on at least one image captured by the imaging device of the mobile device. The visual data may be associated with at least a portion of the at least one image corresponding to a part of the building (e.g., a transparency thereof). The visual data may include at least one of color data, saturation data, hue data, brightness data, contrast data, or any combination thereof.

In some non-limiting embodiments or aspects, the set of color values stored in memory 106 may include a set of transmitted color values. Each transmitted color value may be associated with a transmittance of a transparency that is associated with a transparency identifier of the set of transparency identifiers (e.g., stored in memory 106.). In some non-limiting embodiments or aspects, the set of color values may include a set of reflected color values. Each reflected color value may be associated with a reflectance of a transparency that is associated with a transparency identifier of the set of transparency identifiers.

In some non-limiting embodiments or aspects, method 300 may include, prior to step 302, providing a plurality of visual properties of a plurality of transparencies generated using at least one imaging device. For example, processor 102 may provide a plurality of visual properties (e.g., a table of properties such as transmittance, reflectance, Lcolor value (for transmittance and reflectance), a*color value (for transmittance and reflectance), b*color value (for transmittance and reflectance), R color value (for transmittance and reflectance), G color value (for transmittance and reflectance), B color value (for transmittance and reflectance), and/or the like) for a plurality of transparencies. Processor 102 may then determine a color value from an input from computing device 104, in step 304.

As shown in FIG. 3, method 300 may include, at step 304, determining at least one transparency identifier based on the at least one input. For example, processor 102 may determine at least one transparency identifier based on the at least one input received from the mobile device.

In some non-limiting embodiments or aspects, when determining the at least one transparency identifier based on the at least one input (in step 304), processor 102 may be configured to determine at least one detected color value based on the at least one input, compare the at least one detected color value to a set of color values (each color value of the set of color values being associated with a transparency identifier of a set of transparency identifiers, such as via a unique identifier number), and determine the at least one transparency identifier based on at least one color value of the set of color values being closest or equivalent to the at least one detected color value.

In some non-limiting embodiments or aspects, the set of color values may include a plurality of color value extrema (e.g., a plurality of maximum and minimum value pairs, each forming the extrema pair) each color value extrema of the plurality of color value extrema including a maximum color value and a minimum color value, and each color value extrema of the plurality of color value extrema being associated with a transparency identifier of the set of transparency identifiers. When determining the at least one transparency identifier based on the at least one color value of the set of color values being closest to the at least one detected color value, processor 102 may be configured to determine an average color value of at least one color value extrema of the plurality of color value extrema that is closest to the at least one detected color value.

In some non-limiting embodiments or aspects, processor 102 may be further configured to store, in memory 106, a set of geolocations of a building. Each geolocation of the set of geolocations may be associated with one or more transparency identifiers. In implementations where the input from computing device 104 includes location data of the mobile device, processor 102 may determine at least one detected geolocation from the location data, compare the at least one detected geolocation to the set of geolocations, and determine the at least one transparency identifier based on at least one geolocation of the set of geolocations being closest or equivalent to the at least one detected geolocation.

In some non-limiting embodiments or aspects, where the input may include both location data and visual data, processor 102 may be configured to determine at least one detected geolocation from the location data, compare the at least one detected geolocation to the set of geolocations, and determine a candidate geolocation of the set of geolocations being closest or equivalent to the at least one detected geolocation. Processor 102 may further determine a candidate subset of transparency identifiers based on the candidate geolocation, determine at least one detected color value based on the at least one input, and compare the at least one detected color value to a set of color values, each color value of the set of color values being associated with a transparency identifier of the candidate subset of transparency identifiers. Processor 102 may further determine the at least one transparency identifier based on at least one color value of the set of color values being closest or equivalent to the at least one detected color value.

In some non-limiting embodiments or aspects, step 304 may include determining at least one transparency identifier based on the comparing of the color value to the plurality of visual properties of the plurality of transparencies. For example, the color value that is received via input may correspond (e.g., by proximity, equivalence, and/or the like) to one or more color values in the plurality of visual properties.

As shown in FIG. 3, method 300 may include, at step 306, causing the mobile device to provide the at least one transparency identifier. For example, processor 102 may cause the mobile device to provide the at least one transparency identifier (e.g., a name, an image, a description, etc.) to a user of the mobile device.

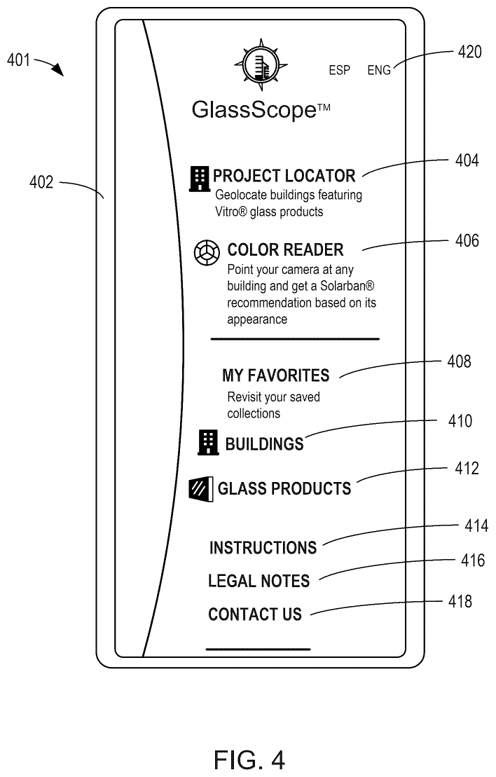

Referring now to FIG. 4, shown is view 401 of a user interface for use in a system and method for identifying transparencies, according to some non-limiting embodiments or aspects. In particular, shown is view 401 of a user interface (e.g., a native application, a web page, etc.) being operated on mobile device 402 (e.g., computer device 104) of a user. View 401 depicts a menu of selectable options, including project locator option 404 (illustratively titled “Project Locator”), color reader option 406 (illustratively titled “Color Reader”), favorites section 408 (illustratively titled “My Favorites”), buildings option 410 (illustratively titled “Buildings”), glass products option 412 (illustratively titled “Glass Products”), instructions option 414 (illustratively titled “Instructions”), legal notes option 416 (illustratively titled “Legal Notes”), add contact option 418 (illustratively titled “Contact Us”), and one or more language selector options 420 (illustratively titled “ESP” for Spanish and “ENG” for English). Each option shown in view 401 may be interactable and may be configured as one or more of a selectable field, button, link, and/or the like. Additionally, or alternatively, favorites section 408 may demarcate a boundary of, and/or include, buildings option 410 and glass products option 412.

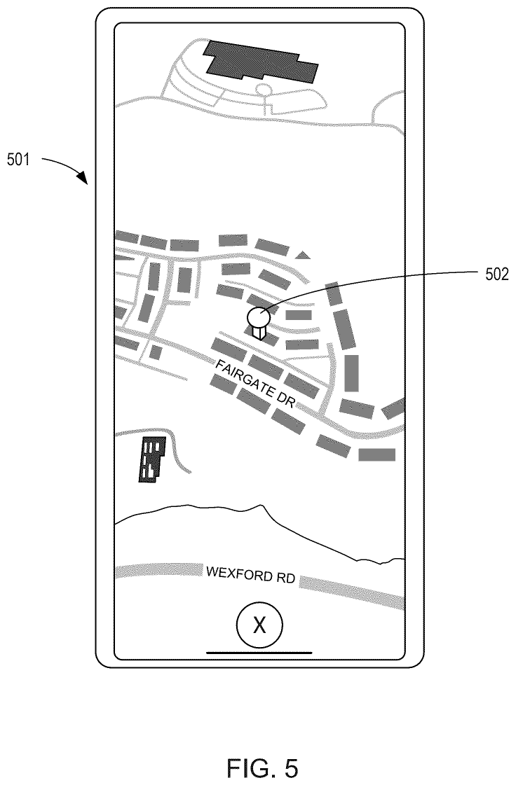

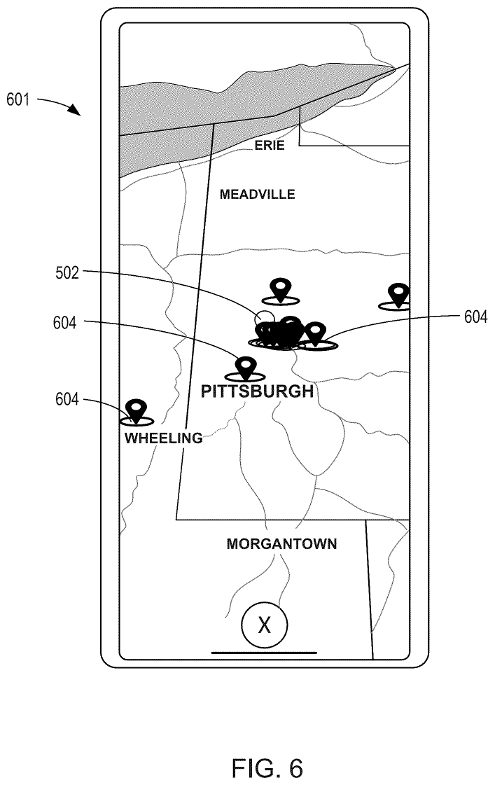

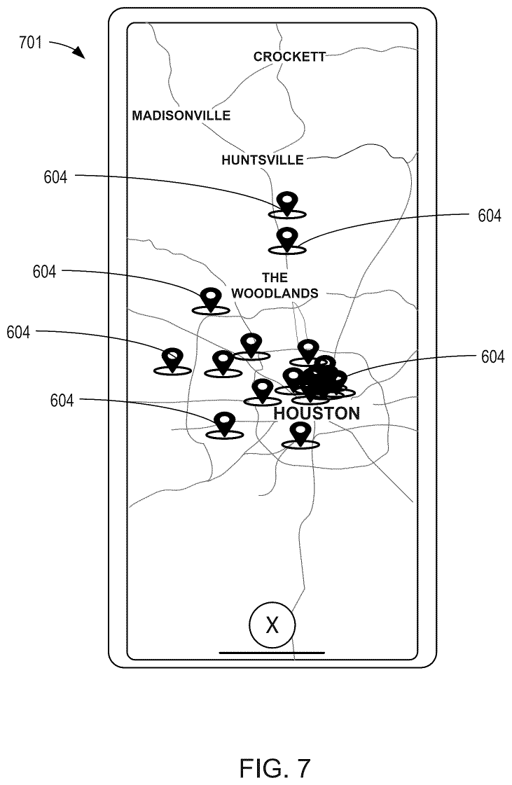

In some non-limiting embodiments or aspects, when the user selects project locator option 404, the user may be redirected (e.g., taken to another window, the display may be updated, the content of a page/screen may be changed, etc.) to a position-based representation of existing, cataloged building projects (e.g., with known properties of transparencies), such as a view illustratively represented by view 501 shown in FIG. 5, view 601 shown in FIG. 6, and/or view 701 shown in FIG. 7. In some non-limiting embodiments or aspects, the positioned-based representation may include a table, listing, searchable database, and/or the like of catalogued building projects that are indexed based, at least partly, on location.

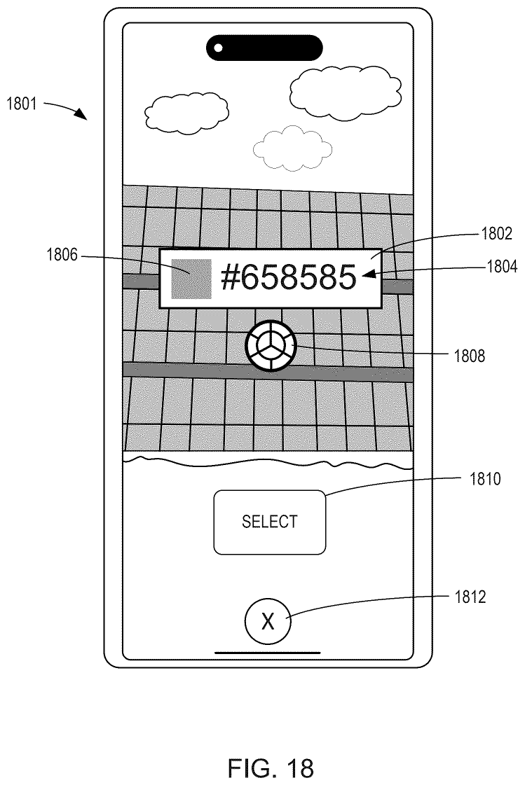

In some non-limiting embodiments or aspects, when the user selects color reader option 406, the user may be redirected to a tool for observing surroundings in the real world and identifying a transparency product that most closely approximates a selected color from the user's environment. For example, selection of color reader option 406 may redirect the user to a view as illustratively represented by view 1801 (shown in FIG. 18).

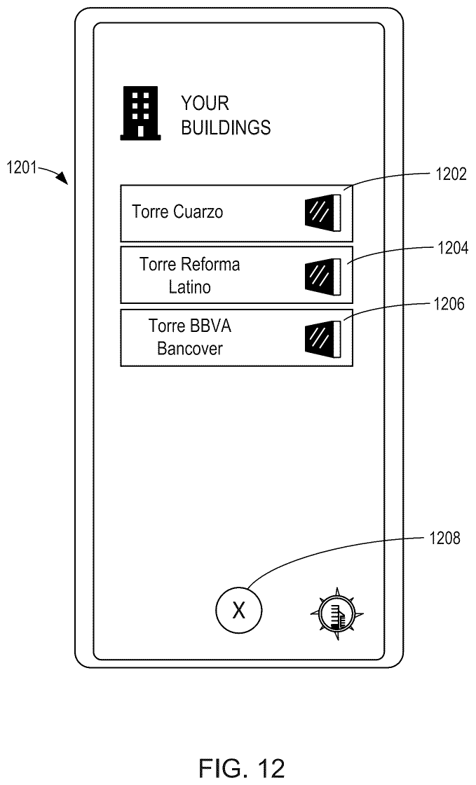

In some non-limiting embodiments or aspects, when the user selects buildings option 410, the user may be redirected to a visual representation of previously saved buildings/building projects (e.g., favorited buildings), for which transparency product information may be known. For example, selection of buildings option 410 may redirect the user to a view as illustratively represented by view 1201 (shown in FIG. 12).

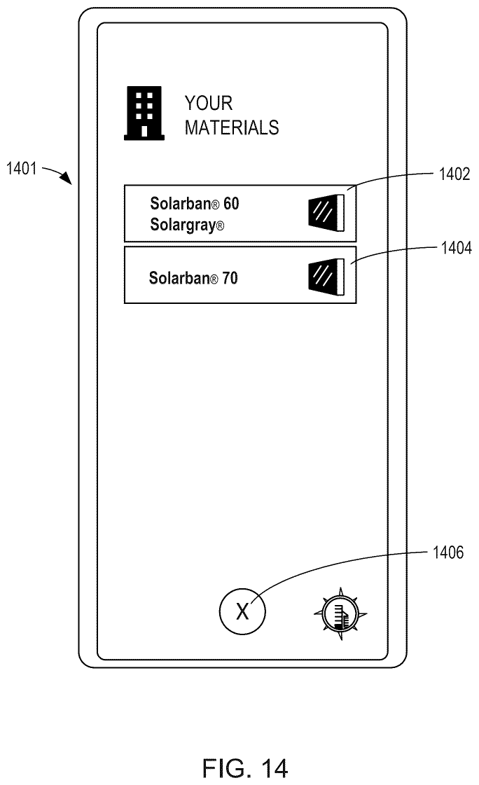

In some non-limiting embodiments or aspects, when the user selects glass products option 412, the user may be redirected to a visual representation of previously saved transparency products (e.g., favorited transparencies), for which transparency product information may be known. For example, selection of glass products option 412 may redirect the user to a view as illustratively represented by view 1401 (shown in FIG. 14).

In some non-limiting embodiments or aspects, when the user selects instructions option 414, the user may be redirected to a visual representation of information to instruct the user on how to use one or more tools, options, pages, views, windows, and/or the like. In some non-limiting embodiments or aspects, when the user selects legal notes option 416, the user may be redirected to a visual representation of information to instruct the user on terms and conditions for use, privacy policy information, and/or the like. In some non-limiting embodiments or aspects, when the user selects contact option 418, the user may be redirected to a visual representation of information to instruct the user on how to contact the service provider of the system, application, website, and/or the like. Additionally, or alternatively, the visual representation provided by selecting the contact option 418 may be a form with various informational fields the user can fill out, which will be transmitted to the service provider upon submission of the form. In some non-limiting embodiments or aspects, when the user selects one of language selector options 420, one or more views shown on mobile device 402 (see, e.g., FIGS. 4-20) may have text rendered in a language associated with the selected option. Additionally, or alternatively, each view depicted in FIGS. 4-20 may be rendered on mobile device 402.

Referring now to FIG. 5, shown is view 501 of a user interface for use in a system and method for identifying transparencies, according to some non-limiting embodiments or aspects. In particular, shown is view 501 of a user interface (e.g., a native application, a web page, etc.) being operated on a mobile device (e.g., mobile device 402, computer device 104) of a user. View 501 may be accessible by user selection of project locator option 404 in view 401 (see FIG. 4). View 501 may depict a map (e.g., a portion of a geographic map). Location pin 502 may be displayed on the map indicating the current position of the computing device operating the user interface. If known cataloged building projects are in the geographic vicinity of location pin 502, and in an area shown on the displayed map, building pins may be shown in the map (see, e.g., FIG. 6).

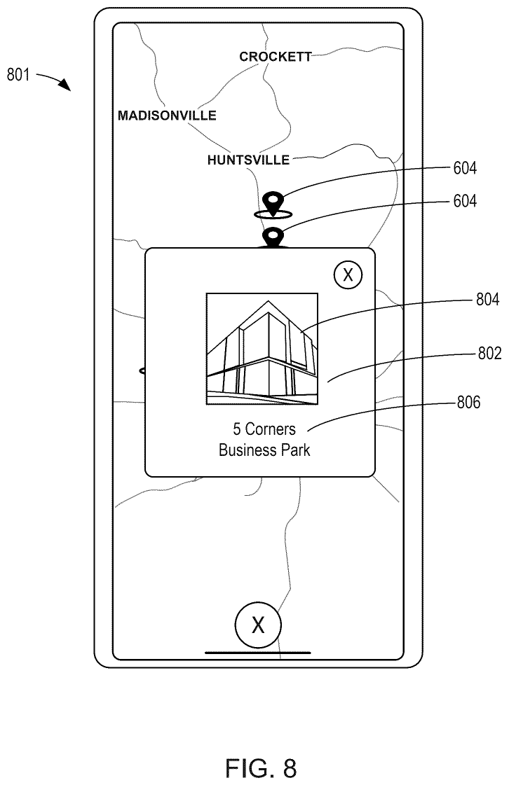

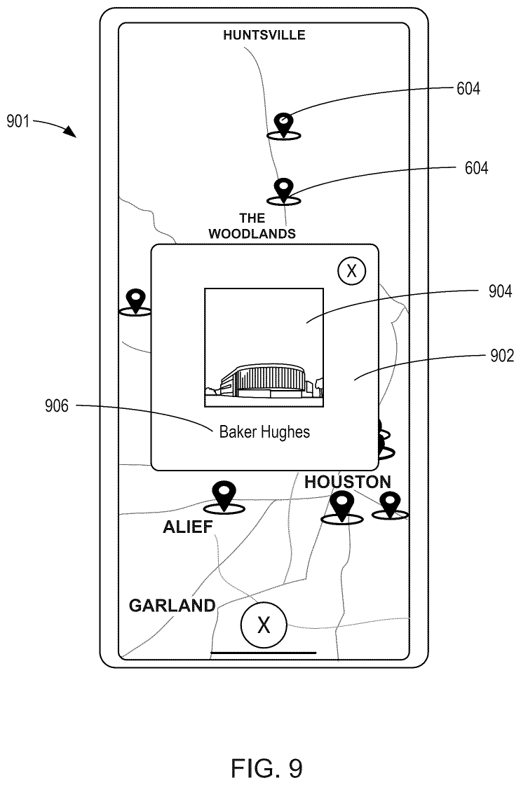

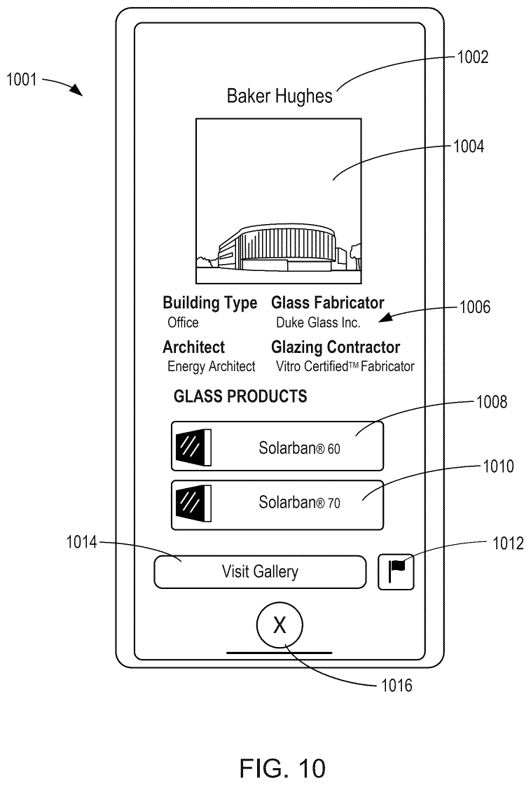

Referring now to FIG. 6, shown is view 601 of a user interface for use in a system and method for identifying transparencies, according to some non-limiting embodiments or aspects. In particular, shown is view 601 of a user interface (e.g., a native application, a web page, etc.) being operated on a mobile device (e.g., mobile device 402, computer device 104) of a user. View 601 may depict a same map as view 501, but where the user has zoomed out to view a wider region. Location pin 502 is still displayed, but now building pins 604 are also visible on the map, allowing the user to view buildings (e.g., each building associated with a building pin 604) for which glass product data has been collected. By selecting one of building pin 604, a visual representation of the selected building pin 604 may be displayed, such as an overlay within view 601 (e.g., as shown in exemplary view 801 of FIG. 8, view 901 of FIG. 9), a separate view from view 601 (e.g., as shown in exemplary view 1001 of FIG. 10), and/or the like.

Referring now to FIG. 7, shown is view 701 of a user interface for use in a system and method for identifying transparencies, according to some non-limiting embodiments or aspects. In particular, shown is view 701 of a user interface (e.g., a native application, a web page, etc.) being operated on a mobile device (e.g., mobile device 402, computer device 104) of a user. View 701 may depict a same map as view 501 and view 601, but where the user has panned (e.g., shifted, moved, navigated, etc.) the map to a different region. Location pin 502 is no longer visible, as the user is now viewing a region where the user (e.g., the user's device) is not located. Additional building pins 604 are visible in this new region of the map. By selecting one of building pin 604, a visual representation of the selected building pin 604 may be displayed, such as an overlay within view 601 (e.g., as shown in exemplary view 801 of FIG. 8, view 901 of FIG. 9), a separate view from view 601 (e.g., as shown in exemplary view 1001 of FIG. 10), and/or the like.

Referring now to FIG. 8, shown is view 801 of a user interface for use in a system and method for identifying transparencies, according to some non-limiting embodiments or aspects. In particular, shown is view 801 of a user interface (e.g., a native application, a web page, etc.) being operated on a mobile device (e.g., mobile device 402, computer device 104) of a user. View 801 may depict the same map and general region as view 701, but after the user has selected one of building pins 604, which may open window 802 (e.g., an overlaid and/or updated section) within view 801 to preview the building associated with the selected building pin 604. Window 802 may include building image 804 and building name 806. Window 802 may provide additional information related to the selected building pin 604, such as information shown in FIG. 10. In some non-limiting embodiments or aspects, selection of building pin 604 may trigger a separate view from view 601 (e.g., as shown in exemplary view 1001 of FIG. 10).

Referring now to FIG. 9, shown is view 901 of a user interface for use in a system and method for identifying transparencies, according to some non-limiting embodiments or aspects. In particular, shown is view 901 of a user interface (e.g., a native application, a web page, etc.) being operated on a mobile device (e.g., mobile device 402, computer device 104) of a user. View 901 may depict the same map and general region as view 801, but after the user has slightly panned the map (e.g., to a generally new regional location) and selected a different one of building pins 604, which may open window 902 within view 901 to preview the new building associated with the new selected building pin 604. Window 902 may include building image 904 and building name 906. Window 902 may provide additional information related to the selected building pin 604, such as information shown in FIG. 10. In some non-limiting embodiments or aspects, selection of building pin 604 may trigger a separate view from view 601 (e.g., as shown in exemplary view 1001 of FIG. 10).

Referring now to FIG. 10, shown is view 1001 of a user interface for use in a system and method for identifying transparencies, according to some non-limiting embodiments or aspects. In particular, shown is view 1001 of a user interface (e.g., a native application, a web page, etc.) being operated on a mobile device (e.g., mobile device 402, computer device 104) of a user. View 1001 may be shown in response to the user selecting an element of window 902 within view 901 (see FIG. 9), such as building image 904 and/or building name 906. Additionally, or alternatively, view 1001 may be shown in response to the user selecting building pin 604. View 1001 may provide additional interactable elements and information about the building, particularly with respect to the glass product (e.g., transparency) being used in connection with the building. For example, view 1001 may depict building name 1002 (e.g., same name as building name 906), building image 1004 (e.g., a same image or different image as building image 904), building summary information 1006 (e.g., describing the building type (e.g., “Office”), the glass fabricator (e.g., “Duke Glass Inc.”), the architect (e.g., “Energy Architecture”), the glazing contractor (e.g., “Vitro Certified Fabricator”), and/or the like), options for learning about one or more glass products used in the construction of the building (e.g., first glass product option 1008 (e.g., associated with “Solarban® 60”), second glass product option 1010 (e.g., associated with “Solarban® 70”, and/or the like), visit gallery option 1014, flag option 1012 (e.g., to save the building as a favorite), exit option 1016, and/or the like. First glass product option 1008, second glass product option 1010, and/or the like may be configured as selectable fields, buttons, links, and/or the like.

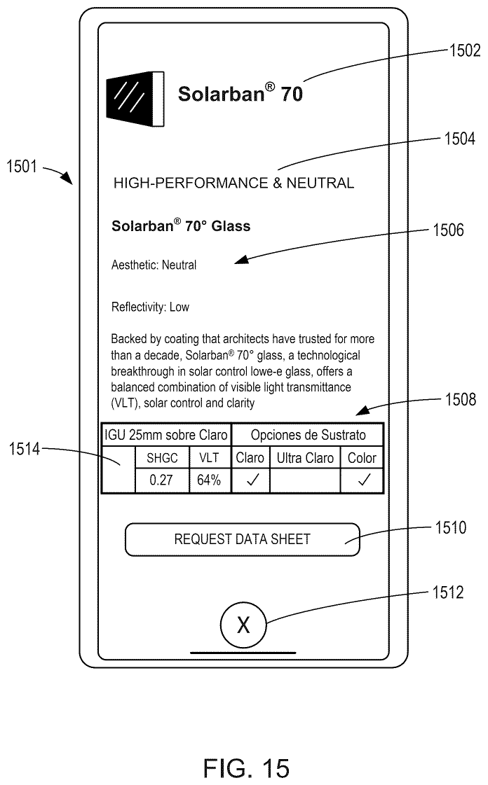

In some non-limiting embodiments or aspects, when the user selects first glass product option 1008 and/or second glass product option 1010, the user may be redirected (e.g., taken to another window, the display may be updated, the content of a page/screen may be changed, etc.) to a visual representation of information pertaining to the respective glass product, such as a view illustratively represented by view 1501 shown in FIG. 15. In some non-limiting embodiments or aspects, when the user selects flag option 1012, the building project associated with view 1001 may be saved to a set of building objects associated with an account of the user (e.g., a user profile).

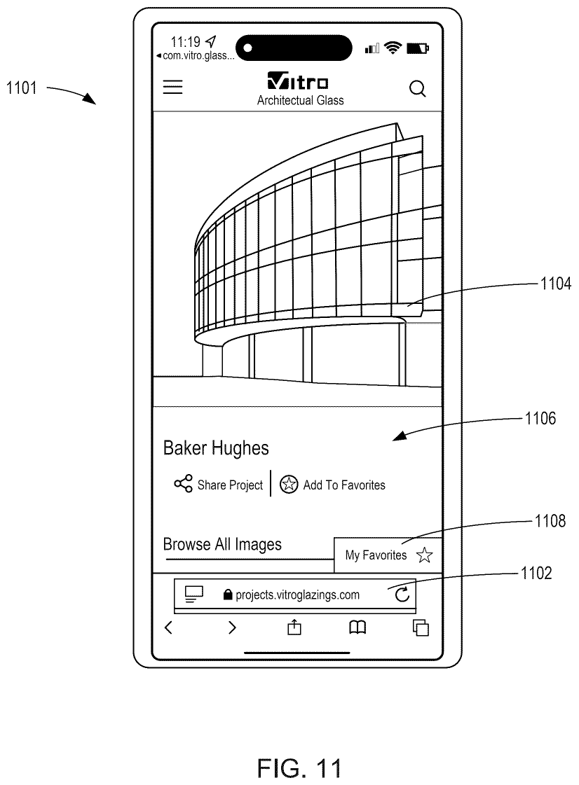

In some non-limiting embodiments or aspects, when the user selects visit gallery option 1014, the user may be redirected to a visual representation of the building project's information in greater detail, such as a view illustratively represented by view 1101 shown in FIG. 11. In some non-limiting embodiments or aspects, when the user selects exit option 1016, the user may be redirected to a view that preceded view 1001 (e.g., immediately prior to or several views before), such as a view illustratively represented by view 401 (see FIG. 4), view 601 (see FIG. 6), view 701 (see FIG. 7), view 801 (see FIG. 8), view 901 (see FIG. 9), view 1201 (see FIG. 12), and/or the like.

Referring now to FIG. 11, shown is view 1101 of a user interface for use in a system and method for identifying transparencies, according to some non-limiting embodiments or aspects. In particular, shown is view 1101 of a user interface (e.g., a native application, a web page, etc.) being operated on a mobile device (e.g., mobile device 402, computer device 104) of a user. View 1101 may be shown in response to the user selecting visit gallery option 1014 in view 1001 (see FIG. 10). For example, view 1101 may include an embedded or launched web browser window providing even further information about the selected building of view 1001. By way of further example, view 1101 may include building image 1104 (e.g., a same or different image as image 1004), building name 1106, favorites option 1108 (e.g., which may function the same as flag option 1012), browser bar 1102, and/or the like, including features for sharing information about the building project, adding the building to the user's favorites, a search button, a menu button, and additional building images and descriptions.

Referring now to FIG. 12, shown is view 1201 of a user interface for use in a system and method for identifying transparencies, according to some non-limiting embodiments or aspects. In particular, shown is view 1201 of a user interface (e.g., a native application, a web page, etc.) being operated on a mobile device (e.g., mobile device 402, computer device 104) of a user. View 1201 may be shown in response to the user selecting buildings option 410 under favorites section 408 of view 401 (see FIG. 4). For example, view 1201 may include a list of buildings that the user has previously saved to their profile (e.g., as a “favorite”). By way of further example, view 1201 may may include first building option 1202 (illustratively titled “Torre Cuarzo”), second building option 1204 (illustratively titled “Torre Reforma Latino”), third building option 1206 (illustratively titled “Torre BBVA Bancomer”), and/or the like. View 1201 may further include exit option 1208, to return the user to view 401 (see FIG. 4).

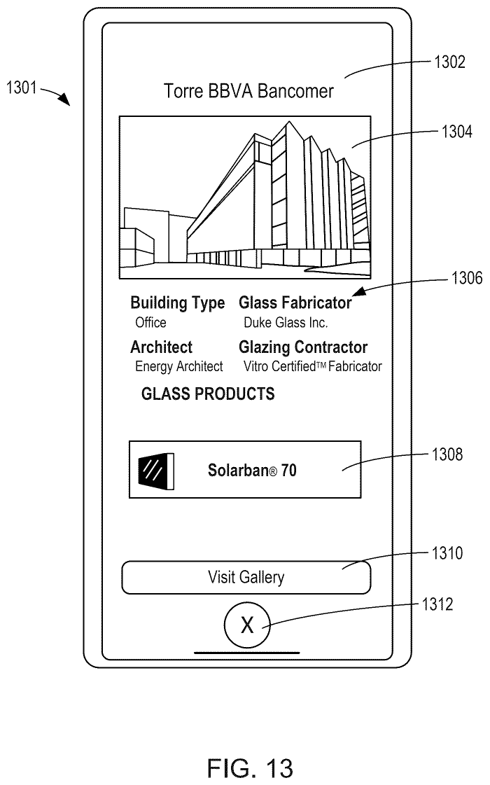

In some non-limiting embodiments or aspects, when the user selects first building option 1202, second building option 1204, third building option 1206, and/or the like, the user may be redirected to a representation of further information associated with the respective building project, such as a view illustratively represented by view 1301 (see FIG. 13). In some non-limiting embodiments or aspects, when the user selects exit option 1208, the user may be redirected to a view that preceded view 1201 (e.g., immediately prior to or several views before), such as a view illustratively represented by view 401 (see FIG. 4) or the like.

Referring now to FIG. 13, shown is view 1301 of a user interface for use in a system and method for identifying transparencies, according to some non-limiting embodiments or aspects. In particular, shown is view 1301 of a user interface (e.g., a native application, a web page, etc.) being operated on a mobile device (e.g., mobile device 402, computer device 104) of a user. View 1301 may be shown in response to the user selecting a building option in view 1201 (see FIG. 12), such as third building option 1206 (as shown). View 1301 may provide additional interactable elements and/or information about the building, particularly with respect to the glass product being used in connection with the building. For example, view 1301 may depict building name 1302 (e.g., same name as shown in connection with third building option 1206), building image 1304, building summary information 1306 (e.g., describing the building type (e.g., “Office”), the glass fabricator (e.g., “Productos de Valor Agregado en Cristal (PVA)”), the architect (e.g., “Legorreta +Legorreta +Rogers”), the glazing contractor (e.g., “Yuanda”), and/or the like), options for learning about one or more glass products used in the construction of the building (e.g., glass product option 1308 (e.g., associated with “Solarban® 70”), and/or the like), visit gallery option 1310, exit option 1312, and/or the like.

In some non-limiting embodiments or aspects, when the user selects glass product option 1308, the user may be redirected (e.g., taken to another window, the display may be updated, the content of a page/screen may be changed, etc.) to a visual representation of information pertaining to the respective glass product, such as a view illustratively represented by view 1501 shown in FIG. 15.

In some non-limiting embodiments or aspects, when the user selects visit gallery option 1310, the user may be redirected to a visual representation of the building project's information in greater detail, such as a view illustratively represented by view 1101 shown in FIG. 11. In some non-limiting embodiments or aspects, when the user selects exit option 1312, the user may be redirected to a view that preceded view 1301 (e.g., immediately prior to or several views before), such as a view illustratively represented by view 401 (see FIG. 4), view 1201 (see FIG. 12), and/or the like.

Referring now to FIG. 14, shown is view 1401 of a user interface for use in a system and method for identifying transparencies, according to some non-limiting embodiments or aspects. In particular, shown is view 1401 of a user interface (e.g., a native application, a web page, etc.) being operated on a mobile device (e.g., mobile device 402, computer device 104) of a user. View 1401 may be shown in response to the user selecting a glass products option (e.g., associated with a set of glass products saved by the user and associated with the user's account), such as glass product option 412 (as shown) under favorites section 408 in view 401 (see FIG. 4). For example, view 1401 may include a list of glass products that the user has previously saved to their profile (e.g., as a “favorite”). By way of further example, view 1401 may include first glass product option 1402 (illustratively titled “Solarban® 60 Solargray®”, as shown), second glass product option 1404 (illustratively titled “Solarban® 70”), and/or the like. View 1401 may further include exit option 1406, to return the user to view 401 (see FIG. 4).

In some non-limiting embodiments or aspects, when the user selects first glass product option 1402 and/or second glass product option 1404, the user may be redirected to a visual representation of information pertaining to the respective glass product, such as a view illustratively represented by view 1501 shown in FIG. 15. In some non-limiting embodiments or aspects, when the user selects exit option 1406, the user may be redirected to a view that preceded view 1401 (e.g., immediately prior to or several views before), such as a view illustratively represented by view 401 (see FIG. 4) or the like.

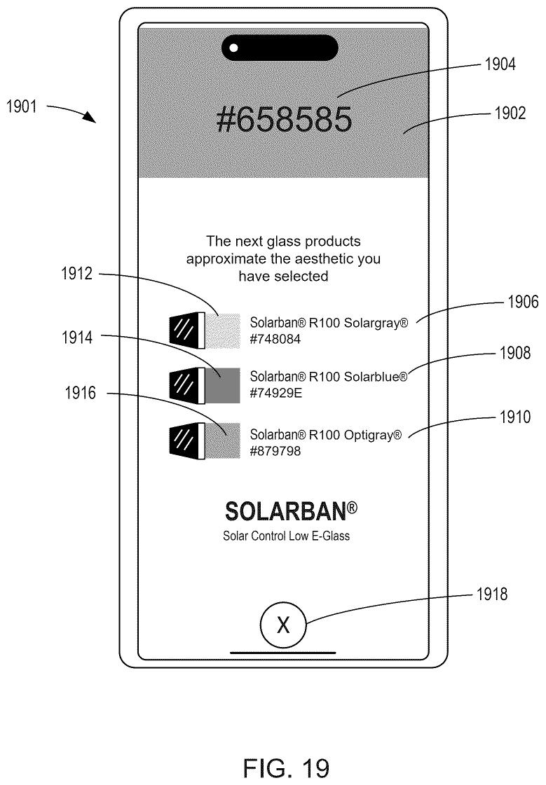

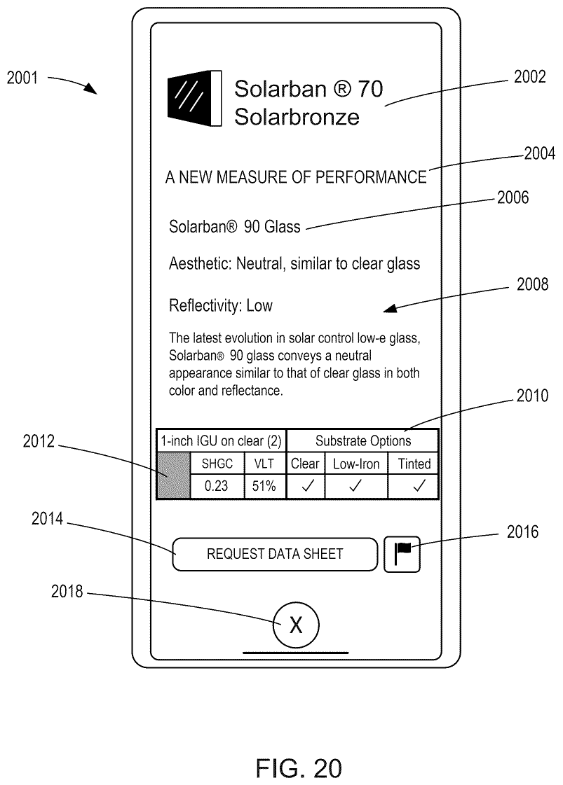

Referring now to FIG. 15, shown is view 1501 of a user interface for use in a system and method for identifying transparencies, according to some non-limiting embodiments or aspects. In particular, shown is view 1501 of a user interface (e.g., a native application, a web page, etc.) being operated on a mobile device (e.g., mobile device 402, computer device 104) of a user. View 1501 may be shown in response to the user selecting a glass product option, such as second glass product option 1404 in view 1401 (see FIG. 14) (reflected in illustrative view 1501), first glass product option 1008 (see FIG. 10), second glass product option 1010 (see FIG. 10), glass product option 1308 (see FIG. 13), first glass product option 1402 (see FIG. 14), first glass product option 1906 (see FIG. 19), second glass product option 1908 (see FIG. 19), third glass product option 1910 (see FIG. 19), and/or the like. View 1501 may provide additional interactable elements and information about the selected glass product. For example, view 1501 may include glass product name 1502, glass product tagline 1504 (e.g., a short, high-level description of the selected glass product), glass product information 1506 (e.g., describing the product's general aesthetic (e.g., “Neutral”), the product's reflectivity (e.g., “Low”), features, appearance, and/or the like), specification table 1508, color sample 1514 (e.g., providing a representative preview of the glass product's default color profile), request data sheet option 1510, exit option 1512 (e.g., to return the user to view 1401), and/or the like. Additionally, or alternatively, view 1501 may include a flag option (such as flag option 2016, shown in FIG. 20).

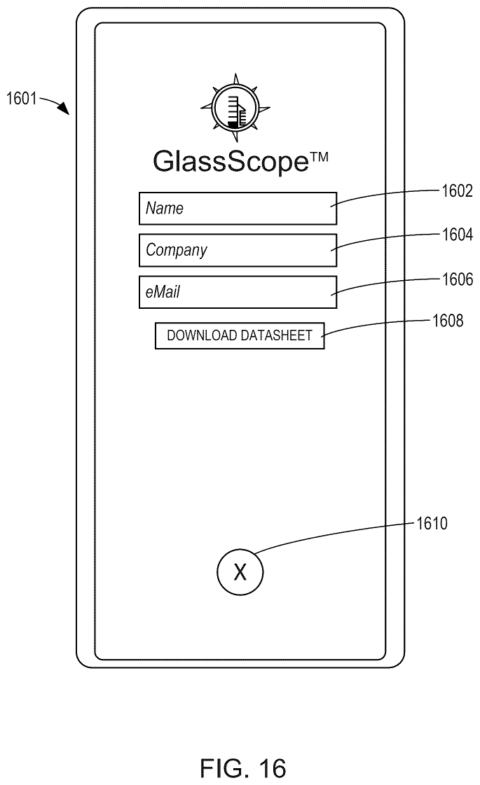

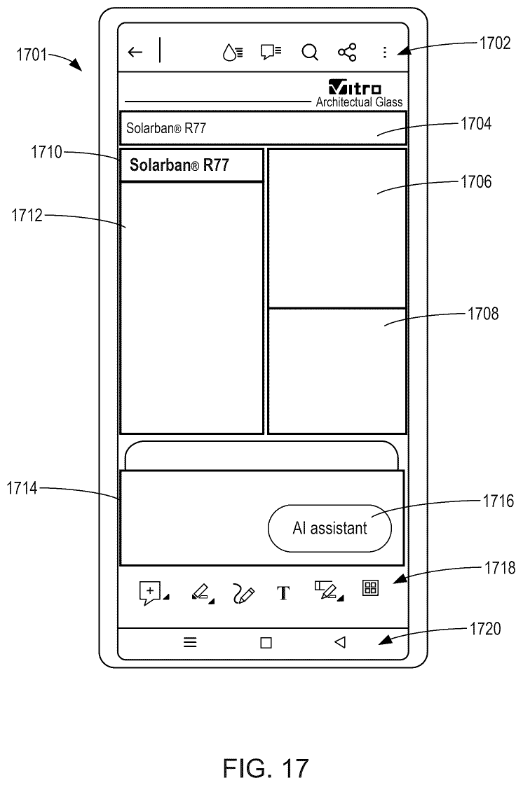

In some non-limiting embodiments or aspects, when the user selects request data sheet option 1510, the user may be redirected to a view for requesting and/or obtaining a data sheet for the respective glass product, such as a view illustratively represented by view 1601 shown in FIG. 16, view 1701 shown in FIG. 17, and/or the like. In some non-limiting embodiments or aspects, when the user selects exit option 1512, the user may be redirected to a view that preceded view 1501 (e.g., immediately prior to or several views before), such as a view illustratively represented by view 401 (see FIG. 4), view 1001 (see FIG. 10), view 1301 (see FIG. 13), view 1901 (see FIG. 19), and/or the like.

Referring now to FIG. 16, shown is view 1601 of a user interface for use in a system and method for identifying transparencies, according to some non-limiting embodiments or aspects. In particular, shown is view 1601 of a user interface (e.g., a native application, a web page, etc.) being operated on a mobile device (e.g., mobile device 402, computer device 104) of a user. View 1601 may be shown in response to the user selecting request data sheet option 1510 in view 1501 (see FIG. 15). View 1601 may provide a form to receive information from the user in order to receive a copy of the data sheet for the selected glass option (e.g., from view 1501). For example, view 1601 may include name field 1602, company field 1604, email address field 1606, download data sheet option 1608, and exit option 1610 (e.g., to return the user to view 1501). In some non-limiting embodiments or aspects, a server of the service provider may verify, validate, and/or authenticate at least one aspect of the user's submitted information (e.g., verify the operability of the user's email) before proceeding to a next view associated with the data sheet (e.g., view 1701, shown in FIG. 17). In some non-limiting embodiments or aspects, when the user selects download data sheet option 1608, the user may be redirected to a visual representation of the data sheet for the respective glass product, such as a view illustratively represented by view 1701 shown in FIG. 17, and/or the like.

Referring now to FIG. 17, shown is view 1701 of a user interface for use in a system and method for identifying transparencies, according to some non-limiting embodiments or aspects. In particular, shown is view 1701 of a user interface (e.g., a native application, a web page, etc.) being operated on a mobile device (e.g., mobile device 402, computer device 104) of a user. View 1701 may be shown in response to the user selecting download data sheet option 1608 in view 1601 (see FIG. 16). View 1701 may include a data sheet viewer (e.g., a PDF viewer, a web browser, a file viewer, an embedded frame, etc.) to permit the user to view highly detailed information about the selected glass product associated with view 1601. For example, view 1701 may include first toolbar 1702 (e.g., including options for commenting, searching, sharing, and/or the like), glass product title 1704, sample use image 1706, product logo 1710, one or more detailed product information sections 1708, 1712, 1714, an AI assistance tool 1716, second toolbar 1718 (e.g., including options for commenting, highlighting, drawing, typing, signing, and/or the like), and page navigation bar 1720 (e.g., with options for navigating the depicted data sheet).

Referring now to FIG. 18, shown is view 1801 of a user interface for use in a system and method for identifying transparencies, according to some non-limiting embodiments or aspects. In particular, shown is view 1801 of a user interface (e.g., a native application, a web page, etc.) being operated on a mobile device (e.g., mobile device 402, computer device 104) of a user. View 1801 may be shown in response to the user selecting color reader option 406 in view 401 (see FIG. 4). View 1801 may make use of the user's computing device's internal and/or external camera in order to sample an image for color. For example, when view 1801 is shown in the user interface, the user may direct their camera to place selector target 1808 over a color to be sampled (e.g., a transparency of a building). Above selector target 1808 may be color information field 1802, which may update color identifier 1804 (e.g., a hexadecimal color code) in real-time in response to the color of the part of the image located around and/or under selector target 1808. Color information field 1802 may further include color sample 1806, which may include a swatch of one uniform color representing the selected color. View 1801 may further include select option 1810, which may allow the user to search for glass products based on the selected color (e.g., reflected by color information field 1802. View 1801 may further include exit option 1812 to allow the user to return back to view 401 (see FIG. 4).

As used herein, the term “real-time” may refer to operation in which data acquisition, processing, and output generation occur with sufficiently low latency such that the resulting output is temporally correlated with, and perceptibly responsive to, corresponding input events. In the context of updating a graphical user interface or display in real time in response to computer inputs (e.g., updating color identifier 1804 in real time with the directional pointing of the user's camera), real-time operation may include receiving input signals (e.g., from a keyboard, pointing device, touchscreen, sensor, or software process), executing one or more processing routines based on the received inputs, and updating one or more visual elements of the display within a time interval that preserves the functional continuity of user interaction. Such time interval may be bounded by system, application, or human-perceptual thresholds (e.g., on the order of milliseconds to tens of milliseconds), such that the display updates appear substantially instantaneous to a user and reflect the current state of the underlying system without perceptible delay.

In some non-limiting embodiments or aspects, when the user selects select option 1810, the user may be redirected to a visual representation of information about one or more glass products (e.g., transparencies) that are the most closely associated with the current selected color, such as a view illustratively represented by view 1901 shown in FIG. 19. In some non-limiting embodiments or aspects, when the user selects exit option 1812, the user may be redirected to a view that preceded view 1801 (e.g., immediately prior to or several views before), such as a view illustratively represented by view 401 (see FIG. 4) or the like.

Referring now to FIG. 19, shown is view 1901 of a user interface for use in a system and method for identifying transparencies, according to some non-limiting embodiments or aspects. In particular, shown is view 1901 of a user interface (e.g., a native application, a web page, etc.) being operated on a mobile device (e.g., mobile device 402, computer device 104) of a user. View 1901 may be shown in response to the user selecting select option 1810 in view 1801 (see FIG. 18). View 1901 may include recommended glass products based on the sampled color from view 1801. For example, view 1901 may include color field 1902 (e.g., demonstrating the selected color), color identifier 1904 (e.g., a hexadecimal color code associated with the sampled color from view 1801), first glass product option 1906 (illustratively titled “Solarban® R100 Solargray® #748084”) associated with first color sample 1912, second glass product option 1908 (illustratively titled “Solarban® R100 Solarblue® #74929E”) associated with second color sample 1914, third glass product option 1910 (illustratively titled “Solarban® R100 Optigray® #879798”) associated with third color sample 1916, and exit option 1918 (e.g., to allow the user to return to view 1801).

In some non-limiting embodiments or aspects, when the user selects first glass product option 1906, second glass product option 1908, and/or third glass product option 1910, the user may be redirected to a visual representation of information about the respective glass product, such as a view illustratively represented by view 2001 shown in FIG. 20. In some non-limiting embodiments or aspects, when the user selects exit option 1918, the user may be redirected to a view that preceded view 1801 (e.g., immediately prior to or several views before), such as a view illustratively represented by view 401 (see FIG. 4), view 1801 (see FIG. 18), and/or the like.

Referring now to FIG. 20, shown is view 2001 of a user interface for use in a system and method for identifying transparencies, according to some non-limiting embodiments or aspects. In particular, shown is view 2001 of a user interface (e.g., a native application, a web page, etc.) being operated on a mobile device (e.g., mobile device 402, computer device 104) of a user. View 2001 may be shown in response to the user selecting a glass product from a suggested list of matching glass products, such as in an iteration of use of the color selector of view 1801 (see FIG. 18). View 2001 may provide additional interactable elements and information about the selected glass product. For example, view 2001 may include glass product name 2002, glass product tagline 2004 (e.g., a short, high-level description of the selected glass product), glass family name 2006, glass product information 2008 (e.g., describing the product's general aesthetic (e.g., “Neutral, similar to clear glass”), the product's reflectivity (e.g., “Low”), features, appearance, and/or the like), specification table 2010, color sample 2012 (e.g., providing a representative preview of the glass product's default color profile), request data sheet option 2014, flag option 2016 (e.g., to save the glass product as a favorite), exit option 2018 (e.g., to return the user to view 1901), and/or the like.

In some non-limiting embodiments or aspects, when the user selects request data sheet option 2014, the user may be redirected to a view for requesting and/or obtaining a data sheet for the respective glass product, such as a view illustratively represented by view 1601 shown in FIG. 16, view 1701 shown in FIG. 17, and/or the like. In some non-limiting embodiments or aspects, when the user selects exit option 2018, the user may be redirected to a view that preceded view 2001 (e.g., immediately prior to or several views before), such as a view illustratively represented by view 401 (see FIG. 4), view 1801 (see FIG. 18), view 1901 (see FIG. 19), and/or the like. In some non-limiting embodiments or aspects, when the user selects flag option 2016, the glass product associated with view 2001 may be saved to a set of glass products associated with an account of the user (e.g., a user profile).

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system, comprising:
at least one processor configured to:
receive at least one input from a mobile device positioned in proximity to a building comprising at least one transparency visible from an exterior of the building;
determine at least one transparency identifier based on the at least one input received from the mobile device; and
cause the mobile device to provide the at least one transparency identifier to a user of the mobile device.

2. The system of claim 1, wherein the at least one input from the mobile device comprises visual data generated by the mobile device based on at least one image captured by an imaging device of the mobile device, and wherein the visual data is associated with at least a portion of the at least one image corresponding to a part of the building.

3. The system of claim 2, wherein the visual data comprises at least one of the following: color data, saturation data, hue data, brightness data, contrast data, or any combination thereof.

4. The system of claim 2, wherein, when determining the at least one transparency identifier based on the at least one input, the at least one processor is configured to:
determine at least one detected color value based on the at least one input;
compare the at least one detected color value to a set of color values, each color value of the set of color values being associated with a transparency identifier of a set of transparency identifiers; and
determine the at least one transparency identifier based on at least one color value of the set of color values being closest or equivalent to the at least one detected color value.

5. The system of claim 4, wherein the set of color values comprises a set of transmitted color values, and wherein each transmitted color value is associated with a transmittance of a transparency that is associated with a transparency identifier of the set of transparency identifiers.

6. The system of claim 4, wherein the set of color values comprises a set of reflected color values, and wherein each reflected color value is associated with a reflectance of a transparency that is associated with a transparency identifier of the set of transparency identifiers.

7. The system of claim 4, wherein the set of color values comprises a plurality of color value extrema, each color value extrema of the plurality of color value extrema comprising a maximum color value and a minimum color value, and each color value extrema of the plurality of color value extrema being associated with a transparency identifier of the set of transparency identifiers.

8. The system of claim 7, wherein, when determining the at least one transparency identifier based on the at least one color value of the set of color values being closest to the at least one detected color value, the at least one processor is configured to determine an average color value of at least one color value extrema of the plurality of color value extrema that is closest to the at least one detected color value.

9. The system of claim 1, wherein the at least one processor is further configured to store, in a memory, a set of geolocations of buildings, each geolocation of the set of geolocations being associated with one or more transparency identifiers, wherein the at least one input comprises location data of the mobile device, and wherein, when determining the at least one transparency identifier based on the at least one input, the at least one processor is configured to:
determine at least one detected geolocation from the location data;
compare the at least one detected geolocation to the set of geolocations; and
determine the at least one transparency identifier based on at least one geolocation of the set of geolocations being closest or equivalent to the at least one detected geolocation.

10. The system of claim 2, wherein the at least one processor is further configured to store, in a memory, a set of geolocations of buildings, each geolocation of the set of geolocations being associated with a subset of transparency identifiers, wherein the at least one input further comprises location data of the mobile device, and wherein, when determining the at least one transparency identifier based on the at least one input, the at least one processor is configured to:
determine at least one detected geolocation from the location data;
compare the at least one detected geolocation to the set of geolocations;
determine a candidate geolocation of the set of geolocations being closest or equivalent to the at least one detected geolocation;
determine a candidate subset of transparency identifiers based on the candidate geolocation;
determine at least one detected color value based on the at least one input;
compare the at least one detected color value to a set of color values, each color value of the set of color values being associated with a transparency identifier of the candidate subset of transparency identifiers; and
determine the at least one transparency identifier based on at least one color value of the set of color values being closest or equivalent to the at least one detected color value.

11. A computer-implemented method, comprising:
receiving, with at least one processor, at least one input from a mobile device positioned in proximity to a building comprising at least one transparency visible from an exterior of the building;
determining, with at least one processor, at least one transparency identifier based on the at least one input received from the mobile device; and
causing, with at least one processor, the mobile device to provide the at least one transparency identifier to a user of the mobile device.

12. The computer-implemented method of claim 11, wherein the at least one input from the mobile device comprises visual data generated by the mobile device based on at least one image captured by an imaging device of the mobile device, and wherein the visual data is associated with at least a portion of the at least one image corresponding to a part of the building.

13. The computer-implemented method of claim 12, wherein determining the at least one transparency identifier based on the at least one input comprises:
determining at least one detected color value based on the at least one input;
comparing the at least one detected color value to a set of color values, each color value of the set of color values being associated with a transparency identifier of a set of transparency identifiers; and
determining the at least one transparency identifier based on at least one color value of the set of color values being closest or equivalent to the at least one detected color value.

14. The computer-implemented method of claim 11, further comprising storing, in a memory, a set of geolocations of buildings, each geolocation of the set of geolocations being associated with one or more transparency identifiers, wherein the at least one input comprises location data of the mobile device, and wherein determining the at least one transparency identifier based on the at least one input comprises:
determining at least one detected geolocation from the location data;
comparing the at least one detected geolocation to the set of geolocations; and
determining the at least one transparency identifier based on at least one geolocation of the set of geolocations being closest or equivalent to the at least one detected geolocation.

15. The computer-implemented method of claim 12, further comprising storing, in a memory, a set of geolocations of buildings, each geolocation of the set of geolocations being associated with a subset of transparency identifiers, wherein the at least one input further comprises location data of the mobile device, and wherein determining the at least one transparency identifier based on the at least one input comprises:
determining at least one detected geolocation from the location data;
comparing the at least one detected geolocation to the set of geolocations;
determining a candidate geolocation of the set of geolocations being closest or equivalent to the at least one detected geolocation;
determining a candidate subset of transparency identifiers based on the candidate geolocation;
determining at least one detected color value based on the at least one input;
comparing the at least one detected color value to a set of color values, each color value of the set of color values being associated with a transparency identifier of the candidate subset of transparency identifiers; and
determining the at least one transparency identifier based on at least one color value of the set of color values being closest or equivalent to the at least one detected color value.

16. A computer program product comprising at least one non-transitory computer-readable medium including program instructions that, when executed by at least one processor, cause the at least one processor to:
receive at least one input from a mobile device positioned in proximity to a building comprising at least one transparency visible from an exterior of the building;
determine at least one transparency identifier based on the at least one input received from the mobile device; and
cause the mobile device to provide the at least one transparency identifier to a user of the mobile device.

17. The computer program product of claim 16, wherein the at least one input from the mobile device comprises visual data generated by the mobile device based on at least one image captured by an imaging device of the mobile device, and wherein the visual data is associated with at least a portion of the at least one image corresponding to a part of the building.

18. The computer program product of claim 17, wherein the program instructions that cause the at least one processor to determine the at least one transparency identifier based on the at least one input cause the at least one processor to:
determine at least one detected color value based on the at least one input;
compare the at least one detected color value to a set of color values, each color value of the set of color values being associated with a transparency identifier of a set of transparency identifiers; and
determine the at least one transparency identifier based on at least one color value of the set of color values being closest or equivalent to the at least one detected color value.

19. The computer program product of claim 16, wherein the program instructions further cause the at least one processor to store, in a memory, a set of geolocations of buildings, each geolocation of the set of geolocations being associated with one or more transparency identifiers, wherein the at least one input comprises location data of the mobile device, and wherein the program instructions that cause the at least one processor to determine the at least one transparency identifier based on the at least one input cause the at least one processor to:
determine at least one detected geolocation from the location data;
compare the at least one detected geolocation to the set of geolocations; and
determine the at least one transparency identifier based on at least one geolocation of the set of geolocations being closest or equivalent to the at least one detected geolocation.

20. The computer program product of claim 16, wherein the program instructions further cause the at least one processor to store, in a memory, a set of geolocations of buildings, each geolocation of the set of geolocations being associated with a subset of transparency identifiers, wherein the at least one input further comprises location data of the mobile device, and wherein the program instructions that cause the at least one processor to determine the at least one transparency identifier based on the at least one input cause the at least one processor to:
determine at least one detected geolocation from the location data;
compare the at least one detected geolocation to the set of geolocations;
determine a candidate geolocation of the set of geolocations being closest or equivalent to the at least one detected geolocation;
determine a candidate subset of transparency identifiers based on the candidate geolocation;
determine at least one detected color value based on the at least one input;
compare the at least one detected color value to a set of color values, each color value of the set of color values being associated with a transparency identifier of the candidate subset of transparency identifiers; and
determine the at least one transparency identifier based on at least one color value of the set of color values being closest or equivalent to the at least one detected color value.
